(19) United States
(12) Patent Application Publication
(10) Pub. No.: US 2006/0290686 A1
(43) Pub. Date: Dec. 28, 2006

(54) Input pen

(75) Inventors: Kouji Shimizu, Tokyo (JP); Hiroki Doui, Tokyo (JP); Hideki Nohechi, Saitama (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: Sony Corporation

(21) Appl. No.: 11/514,105

(22) Filed: Sep. 1, 2006

(30) Foreign Application Priority Data
May 9, 2005 (JP) P2005-256161

(51) Int. Cl. G09G 5/00

(52) U.S. Cl. 345/179

(57) ABSTRACT

Disclosed is an input pen for entering information into an input device by a handwriting input operation. The input pen includes: a grip, to be held by a user for a handwriting input operation, having a shape substantially resembling a flat plate; and a pointed tip continuous with the grip. The grip contains an axis aligned with a center axis of the pointed tip.

### CROSS REFERENCES TO RELATED APPLICATIONS

The present invention contains subject matter related to Japanese Patent Application JP 2005-256161 filed in the Japanese Patent Office on Sep. 5, 2005, the entire contents of which being incorporated herein by reference.

### BACKGROUND OF THE INVENTION

1. Field of the Invention

The present invention relates to an input pen. More specifically, the present invention relates to an input pen provided with a grip having a shape substantially resembling a flat plate to facilitate a handwriting input operation.

2. Description of the Related Art

Handwriting input devices have been prevalently used in recent years. Handwriting input devices is provided with an input unit operated by an input pen. Handwriting input devices include personal computers, personal digital assistances (PDAs) , and electronic devices, such as video cameras. Generally, the handwriting input device is provided with a pen holding part for holding an input pen when the handwriting input device is not in use. Such an input pen as disclosed in Patent document 1 (JP-A 2003-234934) has a pointed tip and a grip having the shape of a round rod.

[Patent document 1] Japanese Patent Laid-Open Publication (JP-A) No. 2003-234934

### SUMMARY OF THE INVENTION

An area of contact between the grip of the known input pen and users fingers is small when the user grips the grip of the input pen because the grip of the known input pen has the shape of a round rod. Therefore, a comparatively high force is necessary to grip the input pen, and the input pen is often gripped unstably, which lead to an obstacle to a use-friendly handwriting input operation.

Accordingly, it is desirable to solve the foregoing problems and to provide an input pen facilitating a handwriting input operation.

An input pen in an embodiment according to the present invention has a grip of a shape substantially resembling a flat plate to be gripped for a handwriting input operation, and a pointed tip formed integrally with the grip, wherein the grip of a shape substantially resembling a flat plate contains an axis aligned with the center axis of the pointed tip.

When a user holds the grip between user's fingers, an area of contact between the grip and the user's fingers is large.

The input pen in the embodiment of the present invention for entering information into a handwriting input device has the grip of a shape substantially resembling a flat plate to be gripped for a handwriting input operation, and the pointed tip formed integrally with the grip, wherein the grip of a shape substantially resembling a flat plate contains an axis aligned with the center axis of the pointed tip.

When a user holds the grip between user's fingers, an area of contact between the grip and the user's fingers is large. Thus the input pen can be firmly held between the user's fingers and facilitates a handwriting input operation.

In an input pen in an embodiment according to the present invention, an end part of the grip extends toward the pointed tip and is connected to the pointed tip. Therefore, a handwriting input operation will not be obstructed by shadows of the input pen and the user's fingers reflected in the handwriting input device and hence a handwriting input operation can be accurately and easily achieved.

In an input pen in a second embodiment according to the present invention, a dimension of the grip in a direction perpendicular to the axis of the grip is greater than a dimension in a direction parallel to the axis of the grip. The grip is easy to grip.

In an input pen in a third embodiment according to the present invention, an inner part of the grip surrounded by a peripheral part of the grip has opposite depressed surfaces. Even if the user's fingers holding the inner part of the grip slip, the peripheral part prevents the user's fingers from slipping off the grip. Thus the input pen will not fall off the user's fingers.

In an input pen in a fourth embodiment according to the present invention, the grip has a strap holding structure, for holding a strap, having a strap receiving opening and a guide groove continuous with the strap receiving opening and formed in a peripheral part of the grip so as to open in the periphery of the grip, the strap receiving opening has a width greater than that of the guide groove, the guide groove has a tapered guide part tapering toward the strap receiving opening and a straight part of a substantially fixed width extending from the strap receiving opening toward the tapered guide part. The strap can be easily inserted through the guide groove into the strap receiving opening and the input pen is prevented from coming off the strap inserted into the strap receiving opening.

### BRIEF DESCRIPTION OF THE DRAWINGS

In the accompanying drawings,

FIG. 1 is a perspective view of a still camera, namely, an electronic device;

FIG. 2 is a perspective view of the still camera showing the rear side of the still camera;

FIG. 3 is an enlarged perspective view of a middle frame;

FIG. 4 is an enlarged perspective view of the middle frame showing the back side of the middle frame;

FIG. 5 is a perspective view of the still camera, in which a battery cover is opened;

FIG. 6 is an exploded perspective view of the middle frame and component parts held on the middle frame;

FIG. 7 is an enlarged perspective view of a part of the middle frame and a shutter unit;

FIG. 8 is an exploded perspective view of the still camera;

FIG. 9 is an enlarged front elevation of a panel holder;

FIG. 10 is an enlarged perspective view of the panel holder;

FIG. 11 is an enlarged perspective view of the panel holder showing positioning parts of the panel holder;

FIG. 12 is a perspective view of a touch panel;

FIG. 13 is a perspective view of a liquid crystal display panel;

FIG. 14 is an enlarged perspective view showing the touch panel and the liquid crystal display panel positioned on the panel holder by a fist positioning structure;

FIG. 15 is a perspective view showing a backlight panel positioned on the panel holder by a second positioning structure;

FIG. 16 is a perspective view of a holding plate;

FIG. 17 is an enlarged sectional view of an assembly of the touch panel, the liquid crystal display panel and the backlight panel;

FIG. 18 is an enlarged sectional view of another assembly of the touch panel, the liquid crystal display panel and the backlight panel;

FIG. 19 is an enlarged sectional view showing the holding plate held by a holding rib of the middle frame;

FIG. 20 is an enlarged perspective view of a battery compartment and a battery;

FIG. 21 is an enlarged perspective view of the battery;

FIG. 22 is an enlarged perspective view showing the battery compartment and a locking member;

FIG. 23 is an enlarged perspective view showing a part of the middle frame, a support member and a spring;

FIG. 24 is an enlarged perspective view of the locking member and the spring;

FIG. 25 is an enlarged perspective view of a locking part of the locking member;

FIG. 26 is an enlarged perspective view of a part of the middle frame, the support member and the spring supported on the middle frame by the support member;

FIG. 27 is an enlarged perspective view showing a part of the middle frame, the support member, the spring and the locking member separated from the middle frame;

FIG. 28 is an enlarged side elevation of assistance in explaining operations of component members during a battery loading operation for loading the battery into the battery compartment, showing a state before the battery is put into a battery receiving chamber;

FIG. 29 is an enlarged perspective view showing a state where the battery is pressed against a bevel surface of the locking member;

FIG. 30 is an enlarged side elevation showing a state where the battery is being put into the battery receiving chamber;

FIG. 31 is a schematic view showing the battery put into the battery receiving chamber in a state before the battery is locked;

FIG. 32 is an enlarged side elevation showing the battery locked in place in the battery receiving chamber;

FIG. 33 is a schematic view showing the battery locked in place in the battery receiving chamber;

FIG. 34 is an enlarged sectional view of assistance in explaining operations of component members during a battery loading operation for loading the battery into the battery compartment and locking the battery by another locking member, showing a state before the battery is put into a battery receiving chamber;

FIG. 35 is an enlarged sectional view showing a state where the battery is being put into the battery receiving chamber;

FIG. 36 is an enlarged sectional view showing the battery locked in place in the battery receiving chamber;

FIG. 37 is an enlarged perspective view of another battery compartment, in which a plug is connected to a connector;

FIG. 38 is an enlarged plan view of a jack case supported on a support wall;

FIG. 39 is an enlarged perspective view of the jack case, in which a cover is closed;

FIG. 40 is an enlarged perspective view of the jack case, in which the cover is closed;

FIG. 41 is an enlarged perspective view of the jack case, in which the cover is opened;

FIG. 42 is a partly cutaway, enlarged side elevation of assistance in explaining opening and closing motions of the cover, in which the cover is closed;

FIG. 43 is an enlarged side elevation showing the cover in a state during an opening motion;

FIG. 44 is a partly cutaway, enlarged side elevation showing the cover in a fully opened state;

FIG. 45 is an enlarged side elevation of an input pen in a preferred embodiment according to the present invention;

FIG. 46 is an enlarged perspective view of the input pen;

FIG. 47 is a sectional view taken on the line XXXXVII-XXXXVII in FIG. 45;

FIG. 48 is a perspective view showing the input pen connected to the still camera by a strap;

FIG. 49 is a perspective view of the input pen in use for an handwriting input operation;

FIG. 50 is an enlarged side elevation of the input pen held in a holding manner different from that illustrated in FIG. 49;

FIG. 51 is an enlarged perspective view of an input pen in another embodiment according to the present invention; and

FIG. 52 is an enlarged perspective view of an input pen in a third embodiment according to the present invention.

### DESCRIPTION OF THE PREFERRED EMBODIMENTS

Embodiments of the present invention will be described below with reference to the drawings.

The embodiments are applied to input pens for entering information into a still camera, namely, an electronic device.

The present invention is not limited in its application to those specifically described herein and may be applied to input pens to be used in combination with electronic devices including video cameras, television receivers, portable telephones, personal computers, PDAs, terminals of networks, workstations and audio systems.

In the following description, terms rightward, leftward, forward, rearward, upward and downward directions are used for indicating directions with respect to a user operating the still camera as a reference position.

The terms rightward, leftward, forward, rearward, upward and downward directions are used for the sake of convenience in described the present invention and are not intended to place restrictions on embodiments of the present invention.

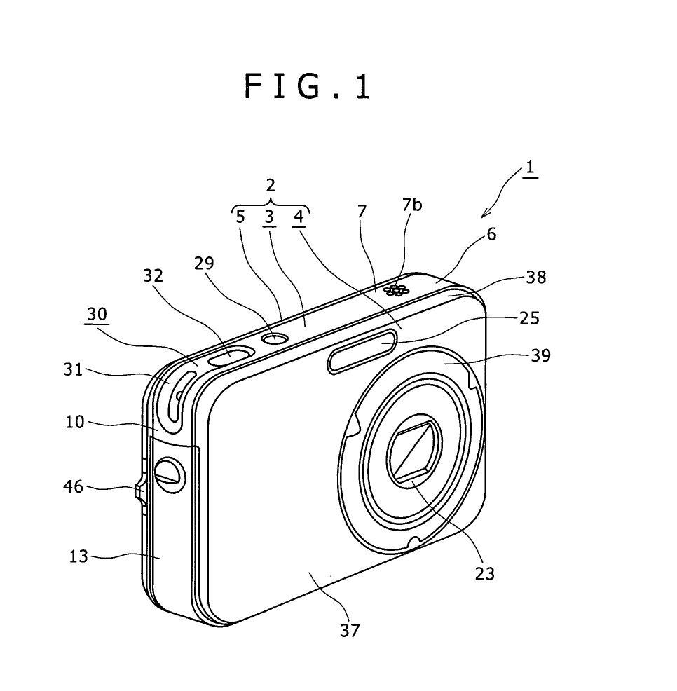

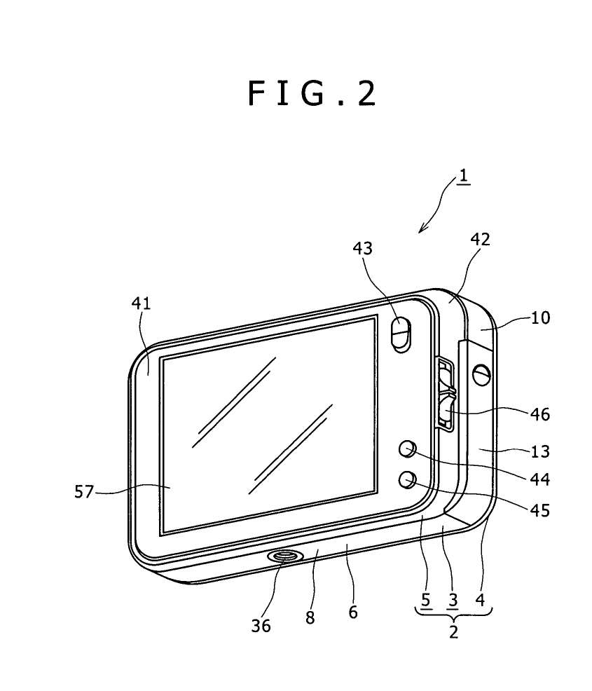

Referring to FIGS. 1 and 2, an electronic device 1 has a body 2 holding component parts therein.

The body 2 has, for example, a laterally elongate, flat shape. The body 2 includes three parts, namely, a middle frame 3, a front panel 4 joined to the front side of the middle frame 3, and a rear panel 5 joined to the rear side of the middle frame 3.

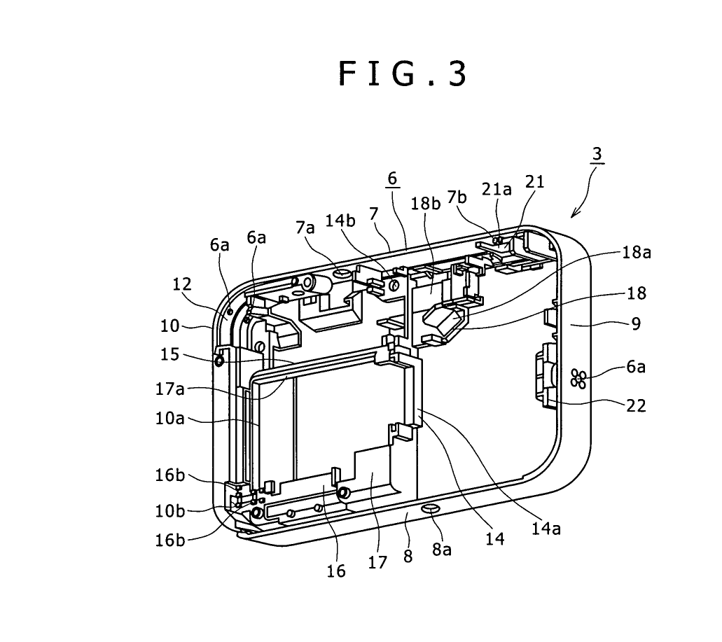

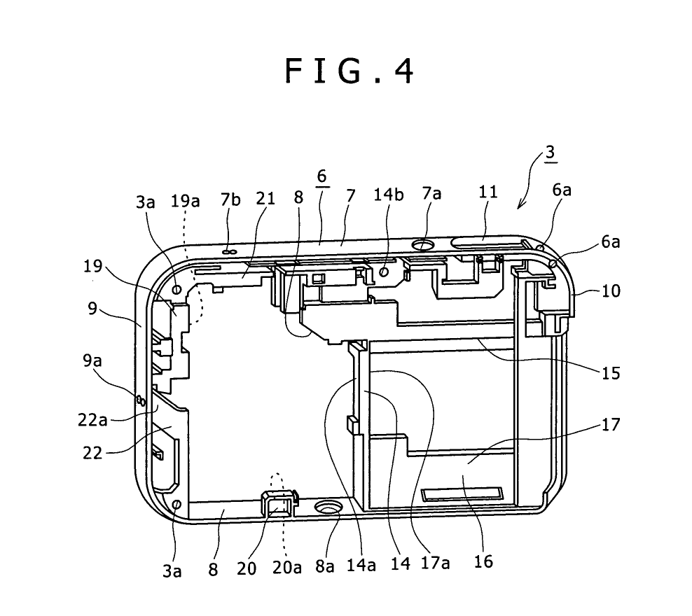

Referring to FIGS. 3 and 4, the middle frame 3 is an integral structure made of a resin and has a laterally elongate frame member 6. The frame member 6 has an upper wall 7, a lower wall 8, a left wall 9 and a right wall 10.

The upper wall 7 is provided with a switch button receiving hole 7a and a microphone receiving hole 7b. A shallow recess 11 opening upward is formed near the switch button receiving hole 7a in the upper wall 7. An operating pin receiving hole 11a is formed in the recess 11.

The frame member 6 is provided with a recess 12 continuous with the recess 11. The recess 12 extends across the boundary between the upper wall 7 and the right wall 10. Axial holes 6a are formed through the front and back wall of the recess 12.

The lower wall 8 is provided in its middle part with a tripod connecting hole 8a.

The left wall 9 is provided with a speaker receiving hole 9a.

The right wall 10 is provided with a vertical slot 10a. A hole 10b is formed near the slot 10a in a lower part of the right wall 10.

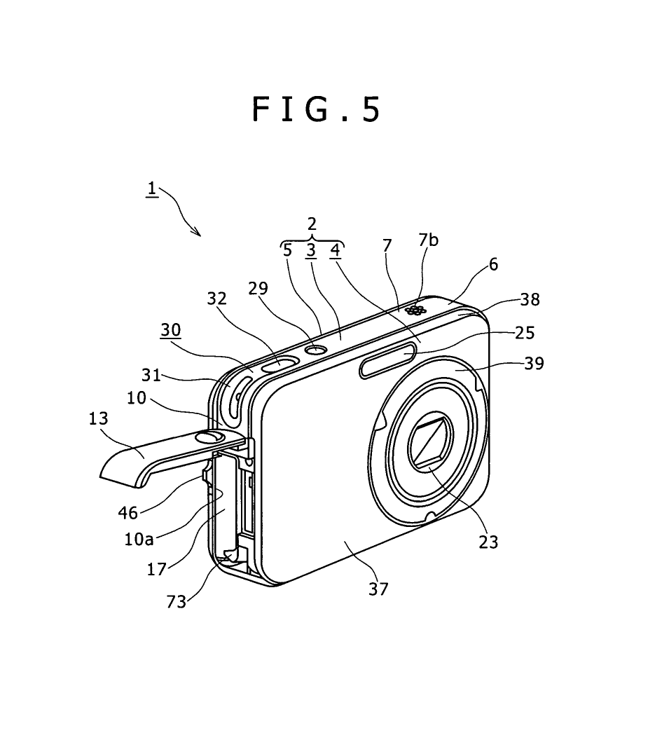

As shown in FIGS. 1 and 5, a long battery cover 13 is supported for opening and closing on the right wall 10. The battery cover 13 turns on its upper end relative to the middle frame 3. Normally the slot 10a and a hole 10b are covered with the battery cover 13.

As shown in FIGS. 3 and 4, a vertical reinforcing member 14 is formed integrally with the middle frame 3 in a laterally middle part of the middle frame 3. The reinforcing member 14 extends between a laterally middle part of the upper wall 7 and a laterally middle part of the lower wall 8. A middle part of the reinforcing member 14 serves as a holding rib 14a.

The reinforcing member 14 extending between the laterally middle part of the upper wall 7 and the laterally middle part of the lower wall 8 reinforces the middle frame 3 and increases the rigidity of the body 2.

Formation of the reinforcing member 14 integrally with the middle frame 3 provides the middle frame 3 with a high strength and reduces the number of component parts.

The middle frame 3 is provided with a laterally extending battery aligning wall 15 having opposite ends connected to an upper part of the reinforcing member 14 and an upper part of the right wall 10, respectively.

The middle frame 3 is provided with a laterally elongate holding wall 16. The holding wall 16 has opposite ends connected to a lower part of the reinforcing member 14 and a lower part of the right wall 10, respectively.

The right wall 10, the battery aligning wall 15, the reinforcing member 14 and the holding wall 16 of the middle frame 3 constitute a battery compartment 17 defining a battery receiving chamber 17a for holding a battery 200 therein.

The middle frame 3 is provided with a holding member 18 formed at the joint of the upper end of the reinforcing member 14 and a substantially middle part with respect to lateral directions of the upper wall 7. The holding member 18 has a unit holding surface 18a. A stroboscopic lamp holding part 18b is formed on the unit holding surface 18a.

The middle frame 3 is provided with a holding member 19 extending over a left end part of the upper wall 7 and an upper half part of the left wall 9. The holding member 19 has a unit holding part 19a.

The middle frame 3 is provided with a holding member 20 rising from a left part of the lower wall 8. The holding member 20 has a holding surface 20a.

The unit holding surfaces 18a, 19a and 20a are recessed slightly.

The middle frame 3 is provided with a microphone holding member 21 formed on the inner surface of the upper wall 7. The microphone holding member 21 is provided with a recess 21a opening toward the front.

The middle frame 3 is provided with a speaker holding member 22 on the inner surface of the left 2 all 9. The speaker holding member 22 is provided with a recess 22a opening toward the rear.

The middle frame 3 is provided respectively in an upper left end part and a lower left end part with longitudinal through holes 3a. The reinforcing member 14 of the middle frame is provided in its upper end part with a longitudinal through hole 14b.

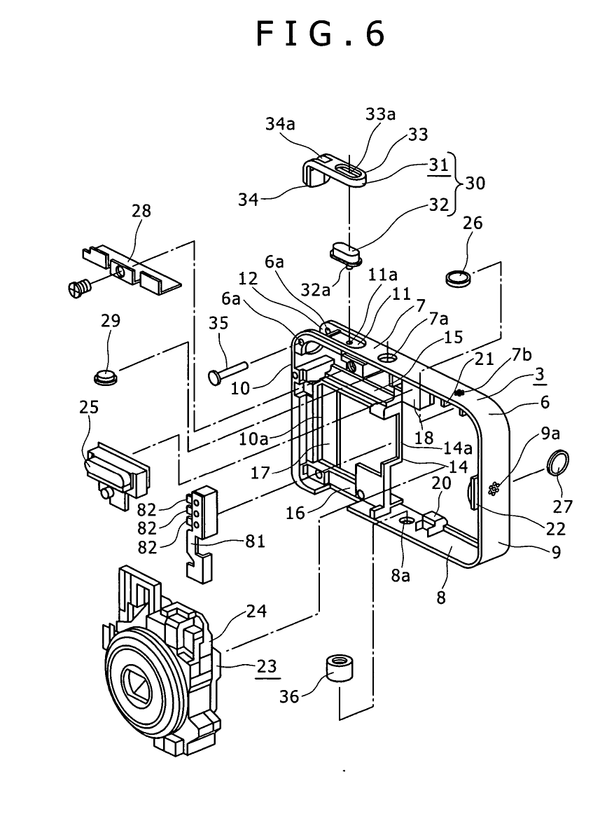

The following component parts are mounted on the middle frame 3 as shown in FIG. 6.

A lens unit 23 is mounted on the holding members 18, 19 and 20 of the middle frame 3. For example, the lens unit 23 is built by assembling a flat lens holder 24, lenses including a focusing lens and zoom lens, an iris mechanism and such. The lens unit 23 is positioned by seating the back surface of a peripheral part of the lens holder 24 on the respective holding surfaces 18a, 19a and 20a of the holding members 18, 19 and 20. The holding surfaces 81a, 19a and 20a serve as positioning surfaces for positioning the lens unit 23.

A stroboscopic lamp 25 is seated on and bonded adhesively to the stroboscopic lamp holding part 18b of the holding member 18.

A substantially disk-shaped microphone 26 is mounted on the microphone holding member 21. The microphone 26 is held in the recess 21a of the microphone holding member 21.

A substantially disk shaped speaker 27 is mounted on the speaker holding member 22. The speaker 27 is held in the recess 22a of the speaker holding member 22.

The lens unit 23, the stroboscopic lamp 25, the microphone 26 and the speaker 27 are functional parts capable of carrying out predetermined functions. The holding surfaces 18a, 19a and 20a, the stroboscopic lamp holding part 18b, the microphone holding member 21 and the speaker holding member 22 are holding members for holding the functional parts.

The parts holding members for holding the functional parts including the lens unit 23, the stroboscopic lamp 25, the microphone 26 and the speaker 27 of the electronic device 1 are formed integrally with the middle frame 3. Therefore, the electronic device 1 does not need any special holding members for holding the functional parts, and the electronic device 1 having a small number of parts can be produced at a low manufacturing cost.

A wiring board holding plate 28 is attached to the inner surface of a right end part of the upper wall 7 of the middle frame 3. A wiring board, not shown, provided with a switching circuit is attached to the wiring board holding plate 28 so as to face the inner surface of the upper wall 7.

A main switch button 29 is placed in the switch button receiving hole 7a.

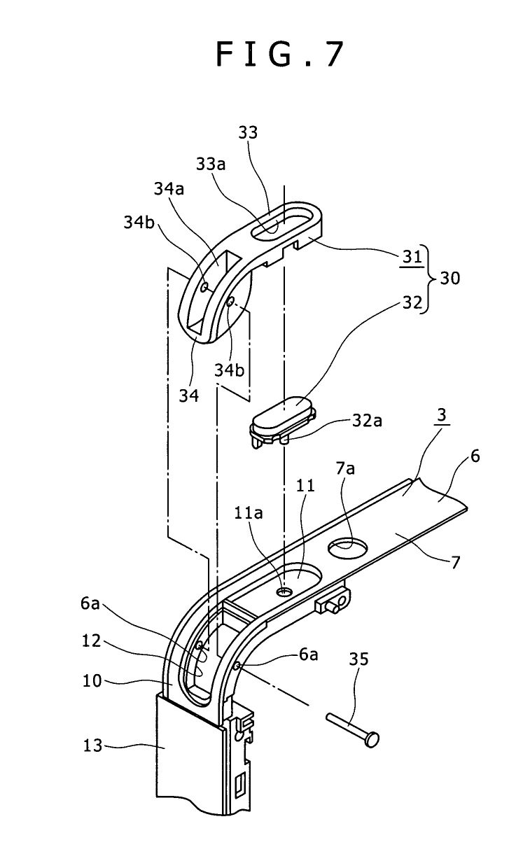

Referring to FIG. 7, a shutter unit 30 is placed in the recess formed in the upper wall 7. The shutter unit 30 includes a base member 31 and a shutter button 32 supported on the base member 31. The base member 31 has a laterally elongate, straight part 33 and a curved part 34 having a shape resembling a circular arc continuously extending from the right end of the straight part 33. A slot 33a is formed so as to extend vertically through the straight part 33. A groove 34a having a depth along a lateral direction is formed in the curved part 34. Longitudinal through holes 34 bare formed in front and rear walls defining the groove 34a.

A shutter button 32 is placed in the slot 33a.

The shutter unit 30 is mounted on the middle frame 3 with the straight part 33 of the base member 31 fitted in the recess 11 and the curved part 34 of the base member 31 fitted in the recess 12 adjacent to the recess 11.

After the shutter unit 30 has been thus mounted on the middle frame 3, a pin 35 is inserted into the holes 6a of the middle frame 3 and the holes 34b of the base member 31 to hold the base member 31 on the middle frame 3 by the pin 35.

A middle part of the pin 35 extends across the groove 34a. A strap can be connected to the middle part of the pin 35.

The pin 35 serves as both a holding member for holding the base member 31 on the middle frame 3 and a strap lug to which a strap is connected. Consequently, the number of component parts can be reduced.

When the electronic device 1 is hung on the strap, the pin 35 is loaded with the weight of the electronic device 1. Since the pin 35 is inserted into the holes 6a of the middle frame 3 and the holes 34b of the base member 31, the pin 35 is held firmly on the middle frame 3 and can bear a heavy weight.

When the shutter unit 30 is attached to the middle frame 3, an operating pin 32a projecting downward from the shutter button 32 projects downward through the operating pin receiving hole 11a formed in the recess 11. Thus the operating pin 32a is able to operate a switch formed on the wiring board attached to the wiring board holding plate 28.

As shown in FIG. 6, a nut 36 provided with a threaded hole is fitted in the tripod connecting hole 8a formed in the lower wall 8 of the middle frame 3. A connecting member provided with an external thread and attached to the upper end of a tripod is screwed into the threaded hole of the nut 36 to mount the electronic device 1 on the tripod.

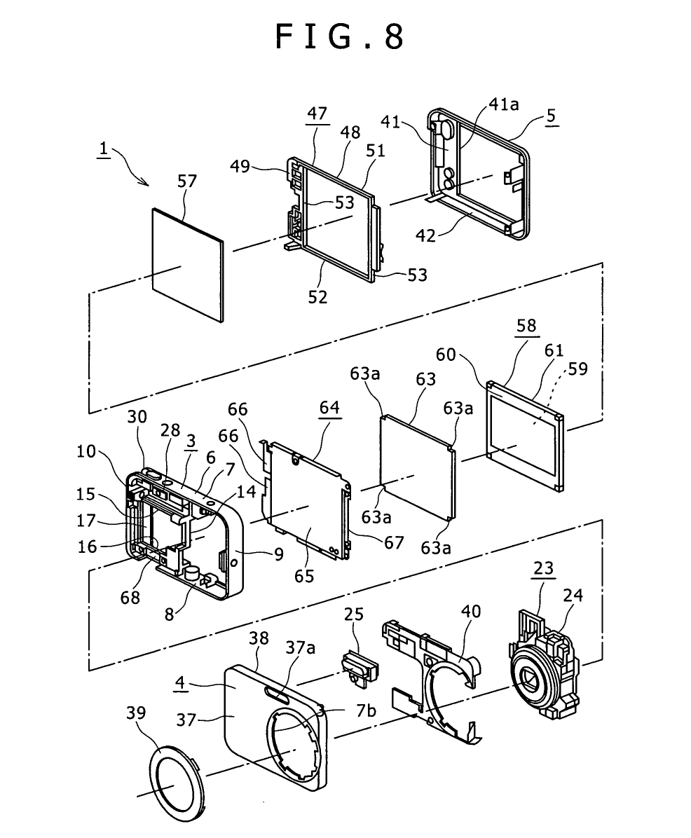

The front panel 4 is made of a metal, such as aluminum. The front panel 4 made of a metal provides the electronic device 1 with an improved heat radiating ability and is capable of efficiently suppressing the rise of temperature inside the electronic device 1. As shown in FIG. 8, the front panel 4 has a laterally elongate, substantially rectangular front wall 37 and a peripheral wall 38 slightly extending rearward from the periphery of the front wall 37. The front wall 37 is provided with a laterally elongate slot 37a in its upper part and with a large opening 37b in its left-hand part.

As shown in FIGS. 1 and 8, a ring 39 is attached to the front wall 37 of the front panel 4 so as to cover the edge of the opening 37b.

A holding member 40 made of, for example, a resin is bonded to the rear surface of the front wall 37 of the front panel 4 with an adhesive or the like. When the front panel 4 is attached to the middle frame 3, the holding member 40 holds the component members mounted on the middle frame 3 in place.

As shown in FIG. 8, the rear panel 5 is made of a metal, such as aluminum. The front panel 4 made of a metal provides the electronic device 1 with an improved heat radiating ability and is capable of efficiently suppressing the rise of temperature inside the electronic device 1.

As shown in FIG. 8, the rear panel 5 has a laterally elongate, substantially rectangular back wall 41 and a peripheral wall 42 slightly extending forward from the periphery of the back wall 41. The back wall 41 is provided with a large, rectangular opening 41a.

As shown in FIG. 2, operating buttons 43, 44 and 45 and a slide knob 46 are disposed at predetermined positions in a right end part of the rear panel 5. The operating buttons 43, 44 and 45 and the slid knob 46 are placed in openings formed in the rear panel 5, respectively. The operating button 43 is a zoom button for zooming. The operating buttons 44 and 45 are, for example, mode changing buttons for changing modes. The slide knob 46 is a selector knob for selecting a mode, such as a photographing mode or a reproducing mode.

The operating button 43 has an upper half part and a lower half part. The upper and the lower half part of the operating button 43 are depressed to select a wide-angle photographing mode and a telephotographing mode, respectively.

As shown in FIG. 8, a panel holder 47 made of, for example, a resin is bonded to the front surface of the back wall 41 of the rear panel 5 with an adhesive or the like.

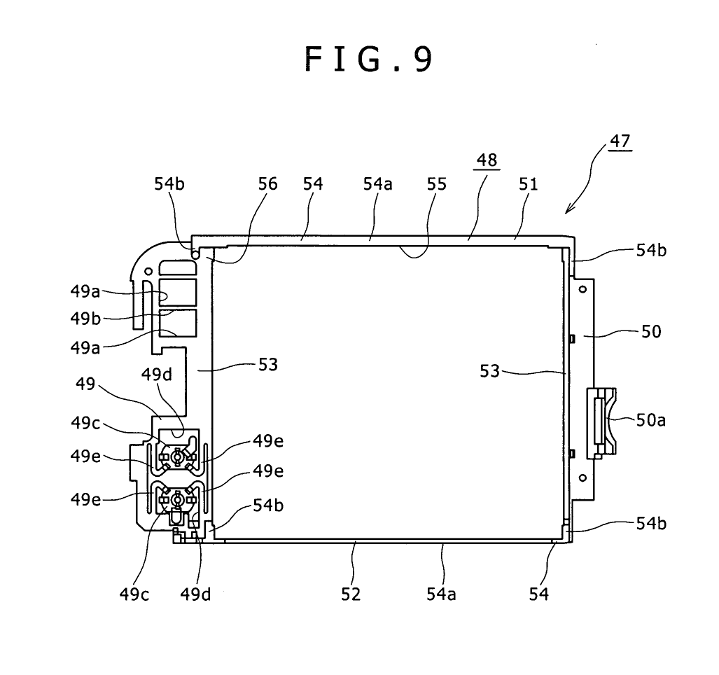

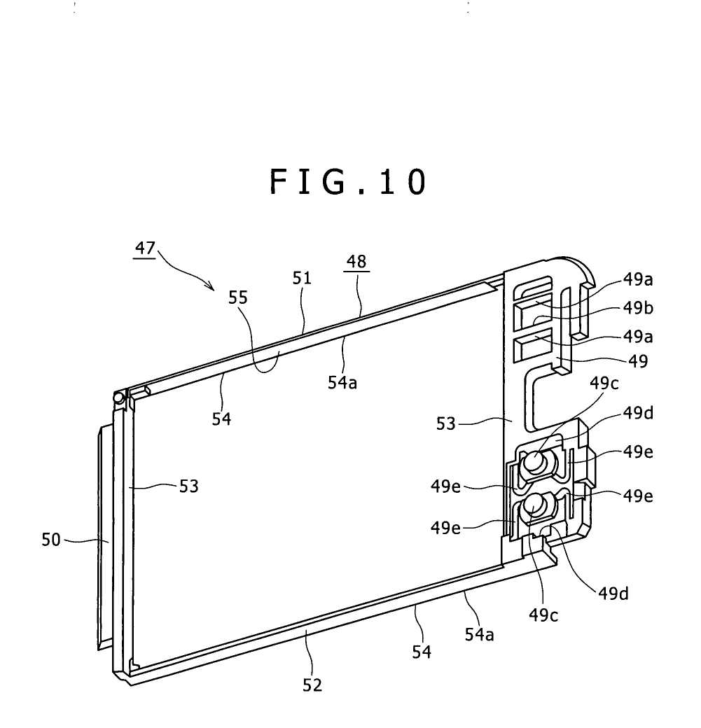

As shown in FIGS. 9 and 10, the panel holder 47 is formed by integrally forming a laterally elongate, rectangular frame 48, an operating member support lug 49 extending outward from the edge of the right member 53 of the frame 48 and a lug 50 protruding outward from the edge of the left member 53 of the frame 48.

The frame 48 has an upper member 51, a lower member 52 and the side members 53. Walls 54 protrude forward from, for example, the upper member 51 and the lower member 52 as shown in FIGS. 9 to 11. The wall 54 protruding from the upper member 51 has an elongate lateral part 54a and vertical parts 54b extending downward from the opposite ends of the lateral part 54a, respectively. The wall 54 protruding from the lower member 52 has an elongate lateral part 54a and vertical parts 54b extending upward from the opposite ends of the lateral part 54a, respectively.

A part, in which the walls 54 are not formed, of the frame 48 serves as a first panel positioning structure 55 positioned on the rear side of the walls 54. The front surfaces of the side members 53 and the walls 54 form a second panel positioning structure 56.

As shown in FIGS. 9 and 10, the operating member support lug 49 of the panel holder 47 is provided with two openings 49a in a vertical arrangement in its upper part. A button support part 49b extends laterally between the openings 49a. The operating button 43, namely, a zoom button, is seated on the button support part 49b. The operating button 43 tumbles on the button support part 49b when the upper and the lower half part of the operating button 43 are depressed alternately.

A switching wiring board, not shown, is placed on the front surface of the operating member support lug 49. The operating button 43 is depressed to operate a push-button switch mounted on the switching wiring board through the opening 49a for zooming.

Since the button support part 49b for supporting the operating button 43 is formed integrally with the panel holder 47, the number of component parts can be reduced.

Two operating plates 49c are placed in a vertical arrangement in a lower part of the operating member support lug 49. The operating plates 49c are placed in openings 49d formed in a vertical arrangement in the operating member support lug 49. Each of the operating plates 49c is supported by two elastically flexible arms 49e on the lower part of the operating member support lug 49.

Operating button 44 and 45 are connected to the rear surfaces of the operating plates 49c, respectively. When the operating buttons 44 and 45 are depressed, the arms 49e are elastically flexed and the operating plates 49c are moved forward. Then, the operating plates 49c operates a push-button switches mounted on the switching wiring board to execute predetermined functions. When the operating buttons 44 and 45 are released, the operating plates 49c are moved rearward by the resilience of the arms 49e to their home positions.

Since the operating plates 49c and the arms 49e to be operated by operating the operating buttons 44 and 45 are formed integrally with the panel holder 47, any special spring or the like for returning the operating buttons 44 and 45 to their home positions are not necessary and hence the number of component parts can be reduced.

The operating buttons 44 and 45 may be formed integrally with the operating plates 49c. The number of component parts can be further reduced by forming the operating buttons 44 and 45 integrally with the operating plates 49c.

The lug 50 of the panel holder 47 has a speaker holder 50a extending forward. In a state where the rear panel 5 is attached to the middle frame 3, the speaker holder 50a holds the speaker 27 placed on the speaker holding member 22 of the middle frame 3 in place. Thus the speaker 27 is restrained from falling off the speaker holding member 22.

A touch panel 57 and a liquid crystal display panel 58 are held at predetermined positions on the panel holder 47.

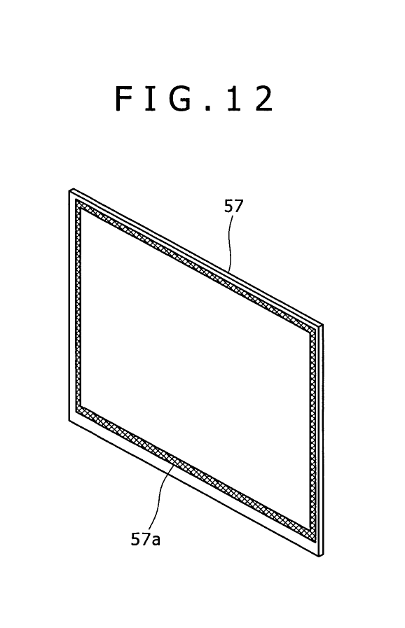

The touch panel 57 is formed in a rectangular shape greater by a size than the rectangular opening 41a of the rear panel 5. The touch panel 57 is a functional device that allows a user to specify predetermined functions by touching areas in the touch panel 57 with a finger or a stylus. Generally, the touch panel 57 is provided with a pattern part 57a for executing operations. As shown in FIG. 12, the pattern part 57a is formed in a peripheral part extending near the circumferential edges of the touch panel 57. The pattern part 57a is the weakest part of the touch panel 57.

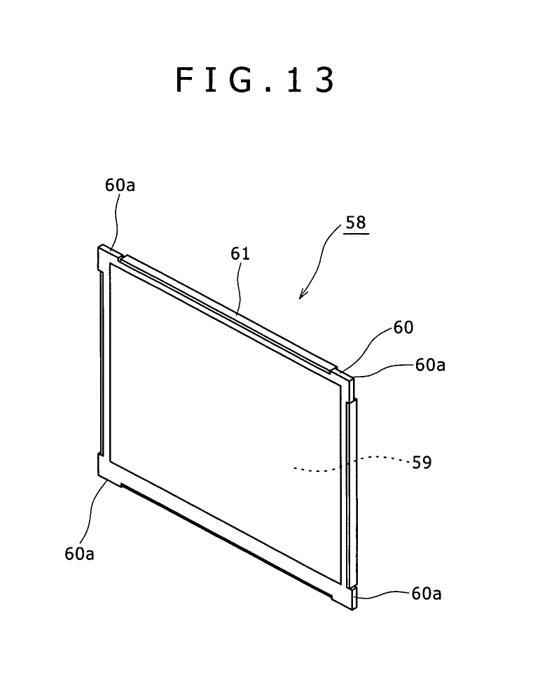

The liquid crystal display panel 58 displays pictures and letters. The liquid crystal display panel 58 has a size substantially equal to that of the touch panel 57. As shown in FIG. 13, the liquid crystal display panel 58 has a liquid crystal display unit 59 and a holding frame 60 holding the liquid crystal display unit 59. Panel mounting members 61 are attached to the holding frame 60.

Four corner parts of the holding frame 60 are expanded outward to form positioning projections 60a.

The panel mounting members 61 covers the holding frame 60 except the positioning projections 60a.

The touch panel 57 and the liquid crystal display panel 58 are bonded together with an adhesive or the like. The pattern part 57a corresponds to a peripheral part of the liquid crystal display unit 59 and extends along the inner edges of the holding frame 60.

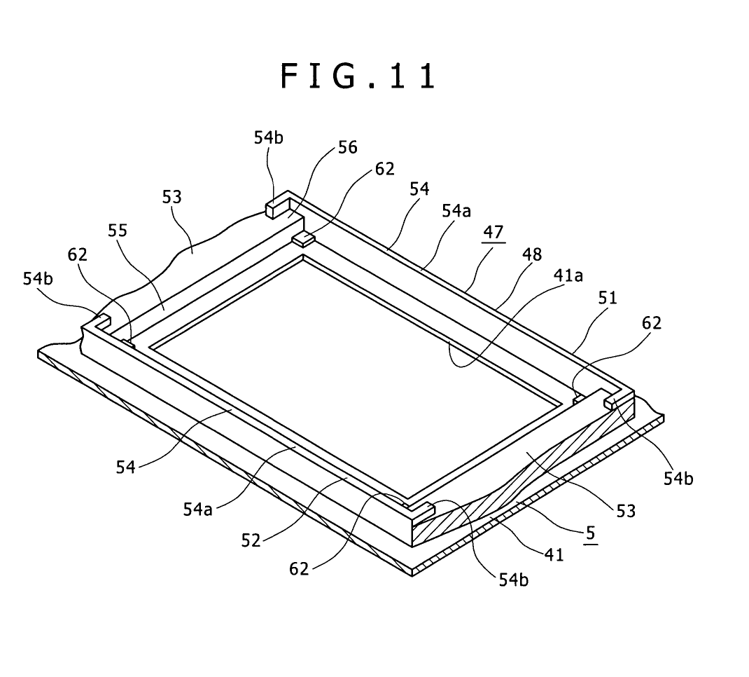

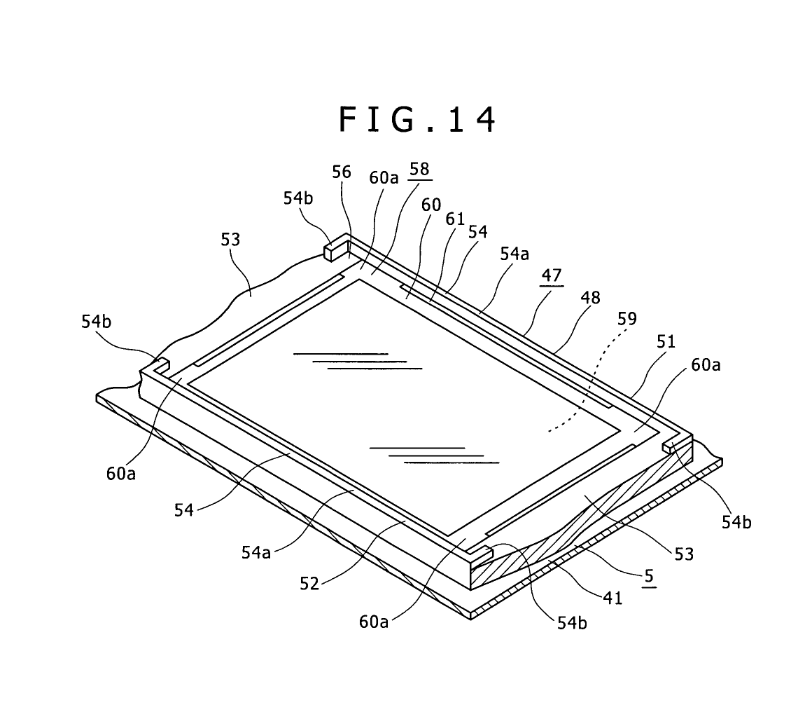

An assembly of the touch panel 57 and the liquid crystal display panel 58 built by bonding the touch panel 57 and the liquid crystal display panel 58 together is held in place on the panel holder 47 attached to the rear panel 5 as shown in FIG. 14. As shown in FIG. 11, cushioning pads 62 are attached to an inner peripheral part, surrounding the opening 41a, of the rear panel 5. The liquid crystal display panel 58 is seated on the cushioning parts 62 and is held in place by the first panel positioning structure 55.

The touch panel 57 and the liquid crystal display panel 58 are positioned accurately by engaging the positioning projections 60a of the liquid crystal display panel 58 in the four corners of the first panel positioning structure 55. Thus the touch panel 57 and the liquid crystal display panel 58 can be positioned on the rear panel 5 in high accuracy.

As shown in FIG. 8 the panel holder 47 holds a backlight panel 63 in place in addition to the touch panel 57 and the liquid crystal display panel 58.

The backlight panel 63 has the shape of a flat plate of a size larger by a size than the liquid crystal display panel 58, For example, the backlight panel 63 is provided with positioning cuts 63a in its four corners.

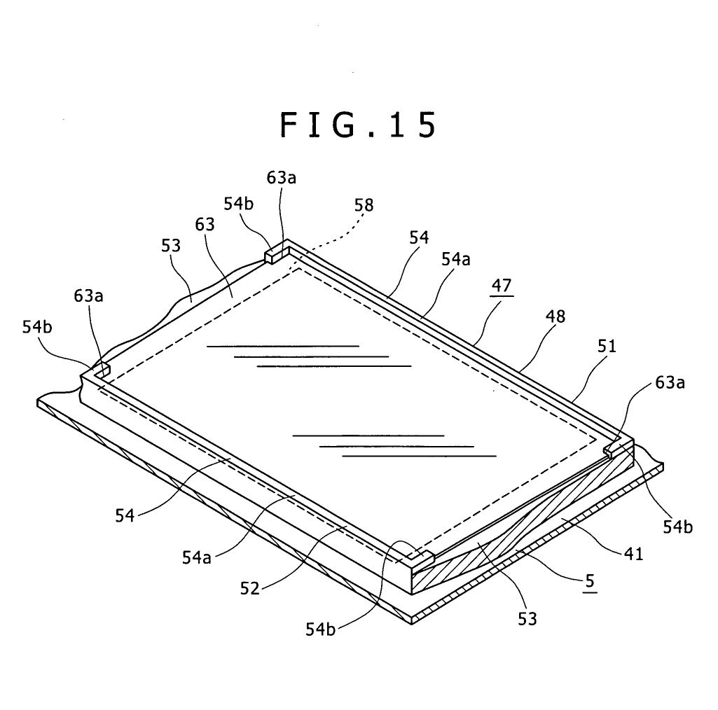

As shown in FIG. 15, the backlight panel 63 is held in place by the panel holder 47 attached to the rear panel 5. The backlight panel 63 is positioned and held by the second panel positioning structure 56 with the vertical parts 54b of the walls 54 engaged in the positioning cuts 63a of the backlight panel 63.

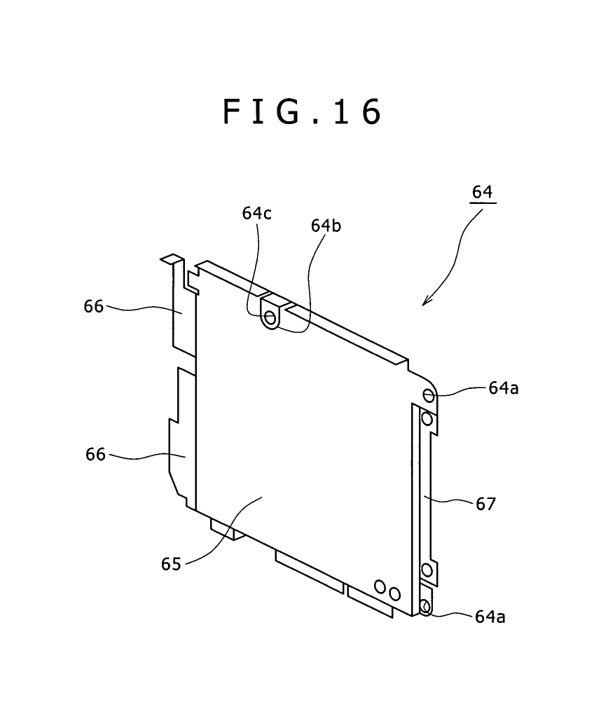

A holding plate 64 put on the front surface of the backlight panel 63 holds the backlight panel 63. As shown in FIG. 16, the holding plate 64 has a laterally elongate, rectangular holding part 65 and lugs 66 and 67 continuously extending from the right and the left edge of the holding part 65. The lugs 66 and 67 recede slightly from the holding part 65. The holding plate 64 is provided with through holes 64a formed in upper and lower parts of a left side part of thereof. An upper middle part of the holding plate 64 is bent forward and downward to form a support lug 64b. A threaded hole 64c is formed in the support lug 64b.

A screw, now shown, is passed through the through hole 14b formed in the reinforcing member 14 and is screwed into the threaded hole 64c to fasten the holding plate 64 to the middle frame 3. Screws, not shown, passed through the through holes 3a of the middle frame 3 and the through holes 64a are screwed in threaded holes, not shown, formed in the rear panel 5 to attach the holding plate 64 to the rear panel 5.

When the holding plate 64 is thus attached to the rear panel 5, the holding part 65 is pressed against the front surface of the backlight panel 63 to press the backlight panel 65 rearward to hold the touch panel 57 and the liquid crystal display panel 58 on the rear panel 5.

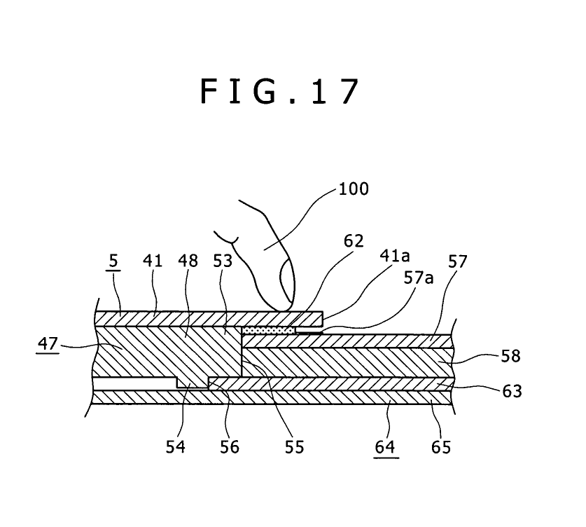

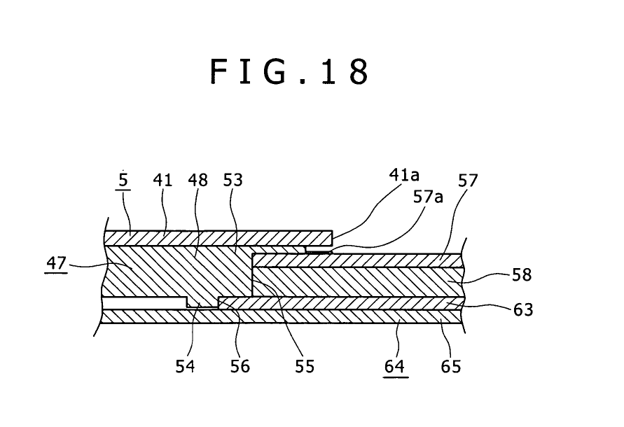

When the touch panel 57, the liquid crystal display panel 58 and the backlight panel 63 are held on the rear panel 5, a gap is formed between the touch panel 57 and an inner peripheral part of the rear panel 5 as shown in FIG. 17.

Therefore, the rear panel 5 will not come into contact with the touch panel 57 when a user holding the electronic device 1 for use touches a part near the opening 41a of the rear panel 5 by a finger 100. Consequently, malfunctioning and breakage of the touch panel 57 can be avoided.

Since the gap is formed between the pattern part 57a, which is the weakest part of the touch panel 57, and the rear panel 5, contact between the pattern part 57 and the rear panel 5 can be avoided. Thus the reliable operation of the touch panel 57 can be insured.

The touch panel 57, the liquid crystal display panel 58 and the backlight panel 63 are held in place on the panel holder 47. Therefore, the touch panel 57, the liquid crystal display panel 58 and the backlight panel 63 can be accurately positioned relative to the rear panel 5 and can be accurately positioned relative to each other.

The cushioning pads 62 are held between the touch panel 57 and the back wall 41 of the rear panel 5. For example, a gap may be formed between the touch panel 57 and the rear panel 5 by spacing the touch panel 57 from the rear panel 5 by spacing protrusions 47a formed by protruding back parts of the panel holder 47 inward.

When the spacing protrusions 47a are formed integrally with the panel holder 47, the cushioning pads 62 may be omitted. Consequently, the number of component parts can be reduced and work for affixing the cushioning pads 62 to the rear panel 5 can be omitted.

The body 2 of the electronic device 1 includes the middle frame 3, the front panel 4 joined to the front side of the middle frame 3, and the rear frame 5 joined to the rear side of the middle frame 3.

The electronic device 1 includes a comparatively small number of component parts, does not require much screwing and staking work and can be easily assembled.

The middle frame 3 sandwiched between the front panel 4 and the rear panel 5 is an integral member. Therefore, the body 2 has a high strength.

The liquid crystal display panel 58 and the backlight panel 63 of the electronic device 1 or the like provided with the touch panel 57 are likely to be loaded when an operating force is applied to the touch panel 57. Since the electronic device 1 is provided with the holding plate 64 for holding the backlight panel 63 and the holding rib 14a for holding the holding plate 64, warping and cracking of the touch panel 57, the liquid crystal display panel 58 and the backlight panel 63 can be surely prevented.

Since the touch panel 57, the liquid crystal display panel 58 and the backlight panel 63 are held in place by the holding plate 64 and the holding rib 14a, the touch [panel 57 and the liquid crystal display panel 58 can be restrained from warping. Consequently, the touch panel 57 and the liquid crystal display panel 58 can be formed in a large size to facilitate using the electronic device 1.

The backlight panel 63 is pressed by the holding plate 64 disposed on the front side of the backlight panel 63, and then the rear panel 5 is fastened to the middle frame 3 by suitable fastening means, such as screws and the front panel 4 is fastened to the middle frame by suitable fastening means, such as screws.

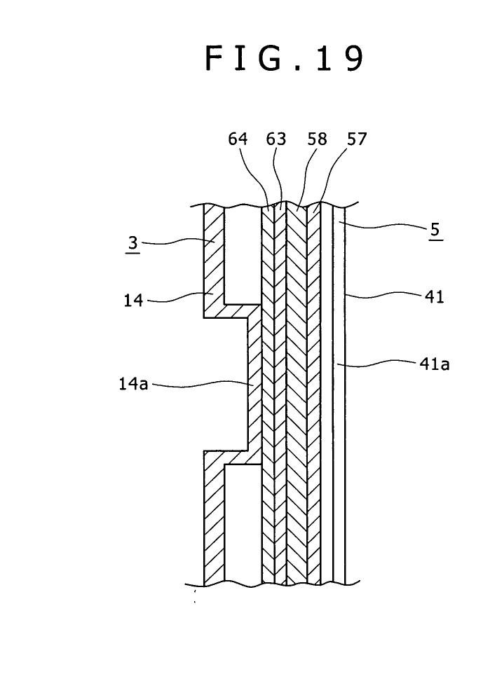

As shown in FIG. 19, the holding rib 14a of the middle frame 3 is pressed against the front surface of the holding part 65 of the holding plate 64 when the middle frame 3 and the rear panel 5 are fastened together. Thus, the holding rib 14a holds the holding plate 64 in place.

Since the holding rib 14a is formed integrally with the middle frame 3, any special part for holding the holding plate 64 is not needed, which reduces the number of component parts.

The holding rib 14a is pressed against the holding plate 64 upon the joining of the middle frame 3 and the rear panel 5. Any special work is not necessary for holding the holding plate 64 by the holding rib 14a, which simplifies assembling work.

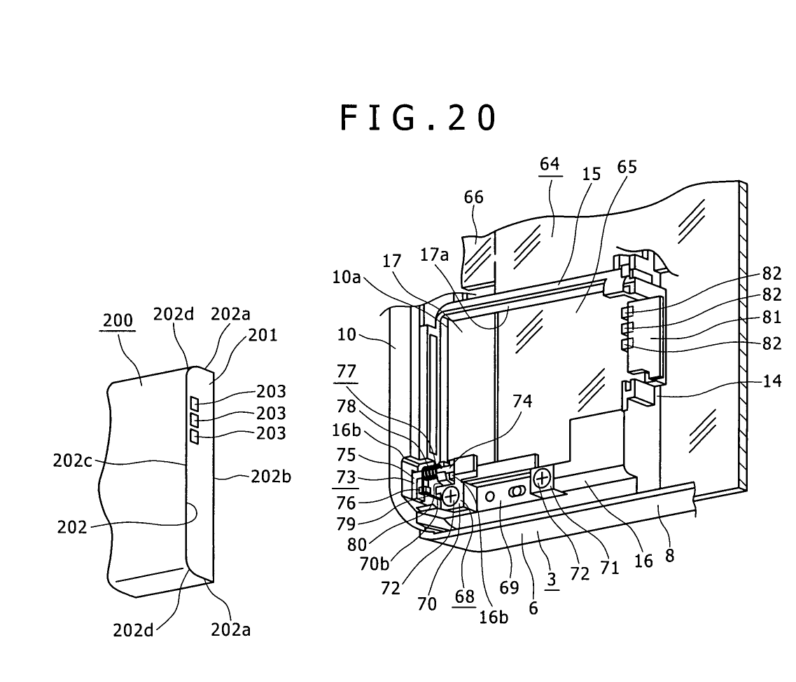

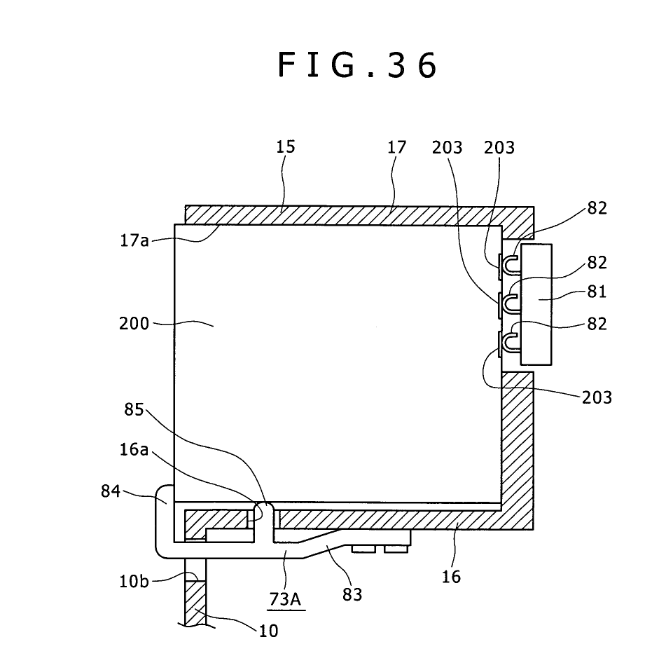

The battery compartment 17 formed in the body 2 and the battery 200 held by the battery compartment 17 will be described with reference to FIGS. 20 to 36.

As mentioned above the right wall 10, the battery aligning wall 15, the reinforcing member 14 and the holding wall 16 of the middle frame 3 constitute the battery compartment 17. As shown in FIG. 20, the battery compartment 17 defines the battery receiving chamber 17a for holding the battery 200 therein.

The right wall 10, the battery aligning wall 15, the reinforcing member 14 and the holding wall 16 constituting the battery compartment 17 are formed integrally with the middle frame 3. Therefore, the electronic device 1 has a comparatively small number of parts and can be manufactured at a comparatively low manufacturing cost.

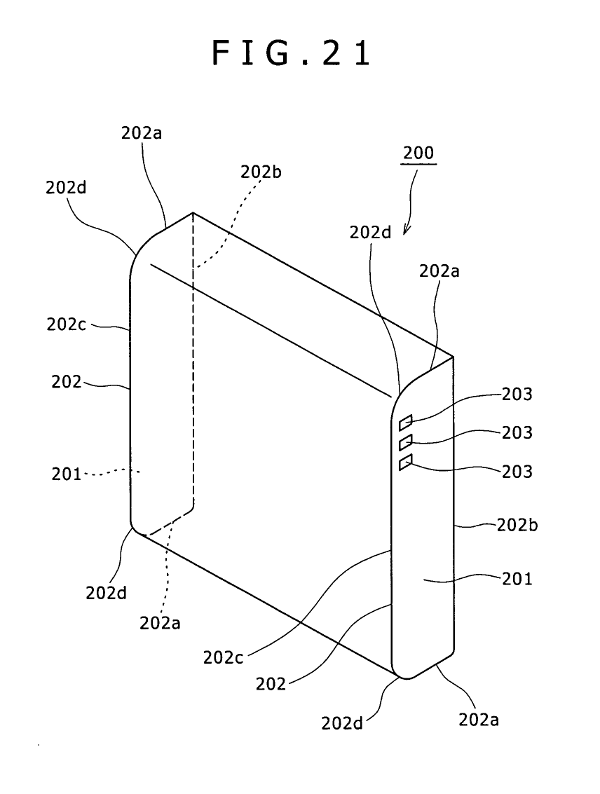

As shown in FIG. 21, the battery 200 has a shape resembling a flat bat having rounded edges. The battery 200 has opposite end surfaces 201 facing a direction in which the battery 200 is inserted into the battery receiving chamber 17a and a direction in which the battery 200 is taken out of the battery receiving chamber 17a, respectively, namely, a front end surface 201 and a back end surface 201. Each of the end surfaces 201 is defined by a circumferential edge 202 having six parts, namely, two first straight parts 202a, a second straight part 202b perpendicular to the first straight parts 202a, a third straight part 202c perpendicular to the first straight parts 202a, and two curved parts 202d curved substantially in a circular arc corresponding to a central angle of about 90°.

The front end surface 201 is provided with three terminals 203 arranged near and along the third straight part 202c.

The third straight part 202c is shorter than the second straight part 202b. The first straight parts 202 are connected to the third straight part 202c by the curved parts 202d, respectively.

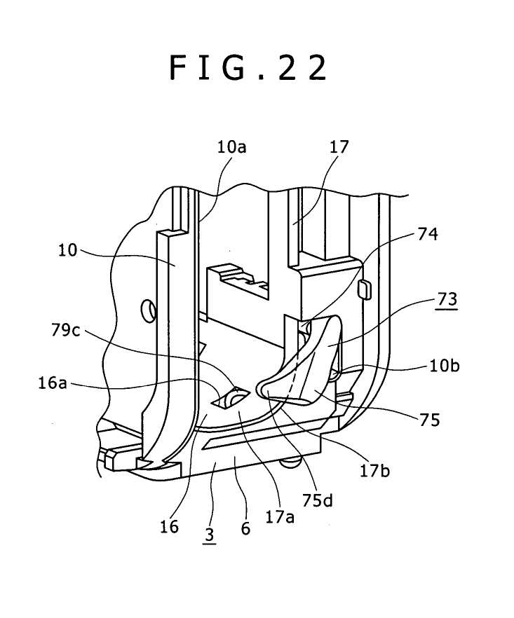

The battery receiving chamber 17a of the battery compartment 17 has a shape corresponding to that of the battery 200. Referring to FIG. 22, an open end of the battery receiving chamber 17a has a curved edge 17b curved in a shape resembling a circular arc corresponding to the shape of the curved part 202d of the battery 200.

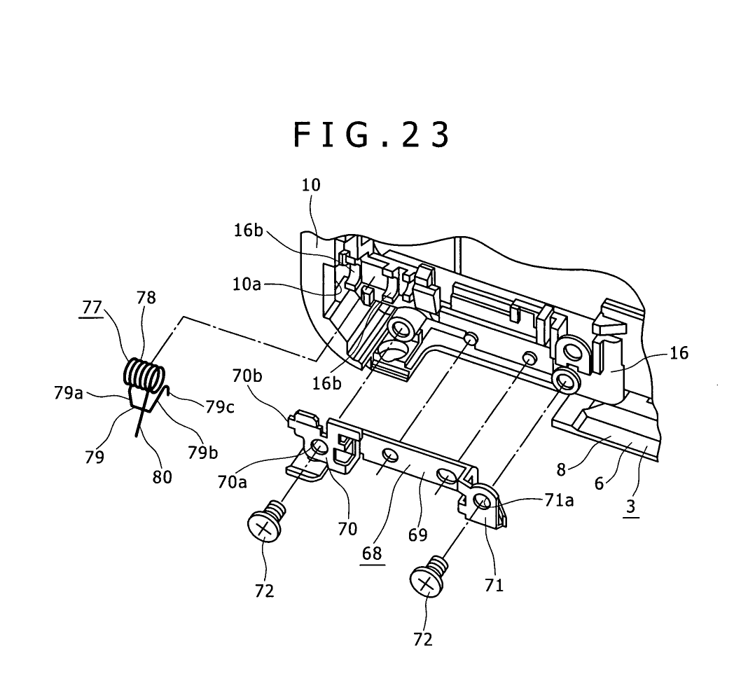

A through hole 16a is formed so as to open into the battery receiving chamber 17a in a part of the holding wall 16 near the right end of the holding wall 16. Referring to FIG. 23, bearing parts 16b are formed near the right end of the front surface of the holding wall 16.

The bearing parts 16b are laterally spaced apart.

A support member 68 is attached to the front surface of the holding wall 16. The support member 68 has a laterally elongate middle part 69 and support parts 70 and 71 continuous with the opposite ends of the middle part 69, respectively. The support parts 70 and 71 are provided with through holes 70a and 71a, respectively. A spring retaining lug 70b rises from the support part 70.

Screws 72 passed through the through holes 70a and 71a of the support parts 70 and 71 are screwed into threaded holes formed in the support wall 16 to attach the support member 68 to the holding wall 16.

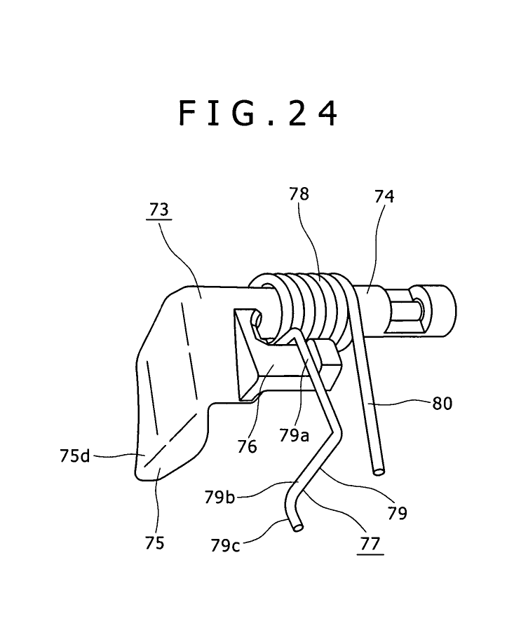

A locking member 73, namely, a locking means, is supported for turning by the bearing parts 16b of the holding wall 16. As shown in FIG. 24, the locking member 73 has a laterally extending shaft 74, a locking part 75 continuous with the right end of the shaft 74, and a spring retaining part 76 protruding from a part near the right end of the shaft 74, which are formed integrally.

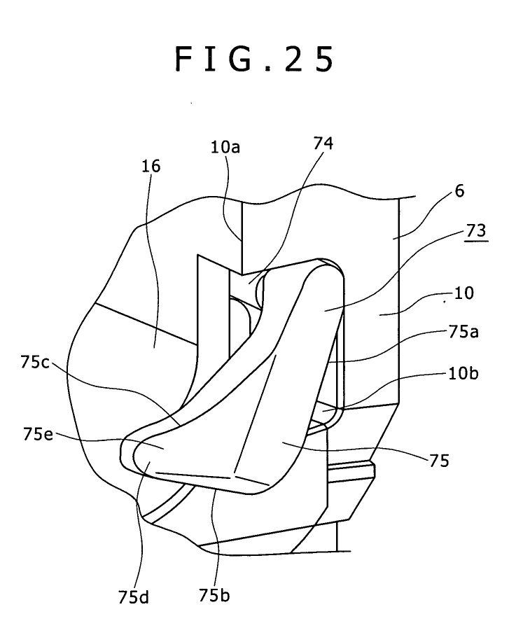

As shown in FIG. 25, the locking part 75 protrudes from the shaft 74 in a direction perpendicular to the axis of the shaft 74 and has a shape substantially resembling a right triangle. The locking part 75 has two straight parts 75a and 75b perpendicularly intersecting each other and a curved part 75c. The curved part 75c is gently curved in a circular arc corresponding to the curved edge 17b of the battery receiving chamber 17a for receiving the battery 200 therein. One of the two corners of the locking part 75 defining angles not substantially equal to 90° is connected to the shaft 74 and the other corner is a tip 75d. A part of a surface of the locking part 75 continuous with the tip 75d is an inclined surface 75e declining toward the tip 75d. Thus the thickness of the locking part 75 decreases toward the tip 75d.

As shown in FIGS. 23 and 24, a spring 77 is mounted on the shaft 74 of the locking member 73. The spring 77 is, for example, a torsion coil spring having a coil body 78, a first leg 79 projecting from one end of the coil body 78 and a second leg 80 projecting from the other end of the coil body 78.

The first leg 79 is bent in a predetermined shape. The first leg 79 has a contact part 79a extending at about 90° to an end coil of the coil body 78, a pressing part 79b extending at about 90° to the contact part 79a, and a curved end part 79c formed in a shape substantially resembling a circular arc continuously with the pressing part 79b. The pressing part 79b is a pressure applying means for applying a pressure to the side surface of the battery 200 loaded into the battery compartment 17.

The coil body 78 of the spring 77 is mounted on the shaft 74 of the locking member 73. The spring 77 is supported on the locking member 73.

As shown in FIG. 20, the shaft 74 of the locking member 73 is supported rotatably by the bearing parts 16b formed on the holding wall 16. Referring to FIG. 22, when the locking member 73 is supported on the middle frame 3, the shaft 74 is above the spring retaining part 76, and the locking part 75 projects outside through vertical slot 10a formed in the right wall 10 of the middle frame 3.

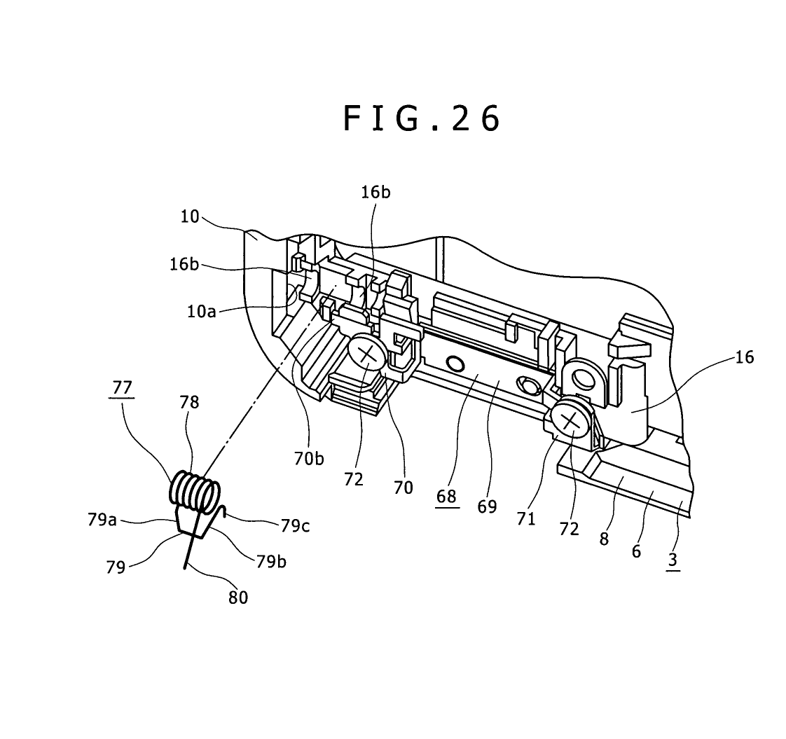

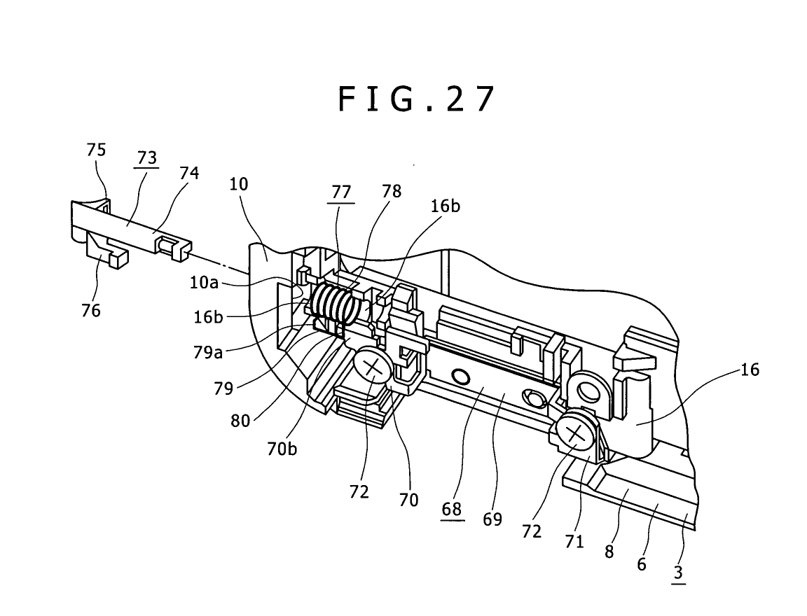

When the locking member 73 is supported on the middle frame 3, the spring 77 lies between the bearing parts 16b formed on the holding wall 16 as shown in FIGS. 26 and 27, the contact part 79a of the first leg 79 is elastically pressed against the front surface of the spring retaining part 76 of the locking member 73 and an end part of the second leg 80 is pressed elastically against the back surface of the spring retaining lug 70b of the support member 68 attached to the holding wall 16 as shown in FIGS. 20 and 24. Thus the locking member 73 is urged rotationally by the spring 77 so as to turn on the shaft 74 such that the spring retaining part 76 moves substantially forward. The spring retaining part 76 comes into contact with the holding wall 16 to limit the turning of the locking member 73. In a state where the spring retaining part 76 rests on the holding wall 16, the tip 75d of the locking part 75 extends beyond the curved edge 17b into the battery receiving chamber 17a as shown in FIG. 22. The curved end part 79c continuous with the pressing part 79b of the spring 77 projects through the through hole 16a of the middle frame 3 into the battery receiving chamber 17a as shown in FIG. 22.

As shown in FIG. 20, a power circuit wiring board 81 is attached to the holding rib 14a of the reinforcing member 14 of the middle frame 3. The power circuit wiring board 81 is provided with terminals 82 in a vertical arrangement.

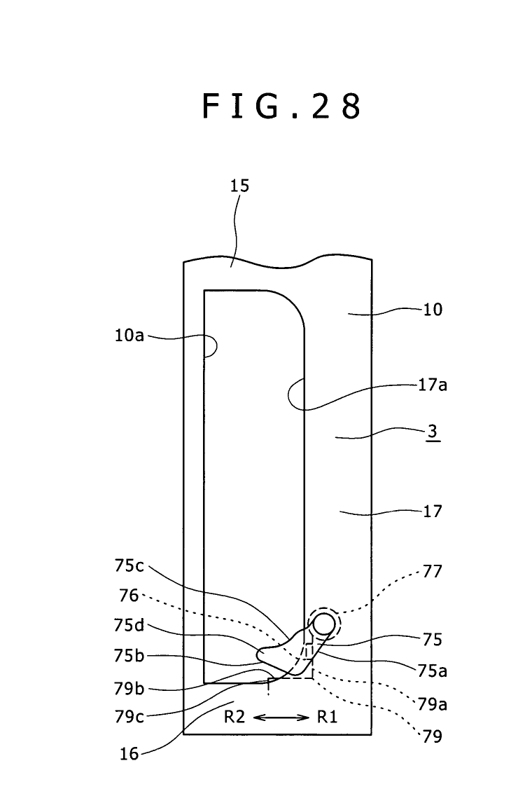

Operations that are performed by parts when the battery 200 is loaded into and unloaded from the battery receiving chamber 17a will be described with reference to FIGS. 28 to 31.

As shown in FIG. 28, the tip 75d of the locking part 75 of the locking member 73 protrudes through the curved edge 17b into the battery receiving chamber 17a before the battery 200 is loaded into the battery receiving chamber 17a. At this stage, the curved end part 79c continuous with the pressing part 79b of the spring 77 protrudes through the through hole 16a of the middle frame 3 into the battery receiving chamber 17a.

When the battery 200 is loaded into the battery receiving chamber 17a, the battery cover 13 is opened, the locking member 73 is turned in the direction of the arrow R1 (FIG. 28) against the resilience of the spring 77 to retract the curved end part 79c of the spring from the battery receiving chamber 17a. The locking member 73 is turned in the direction of the arrow R1 by holding the locking part 75 between fingers and turning the locking part 75.

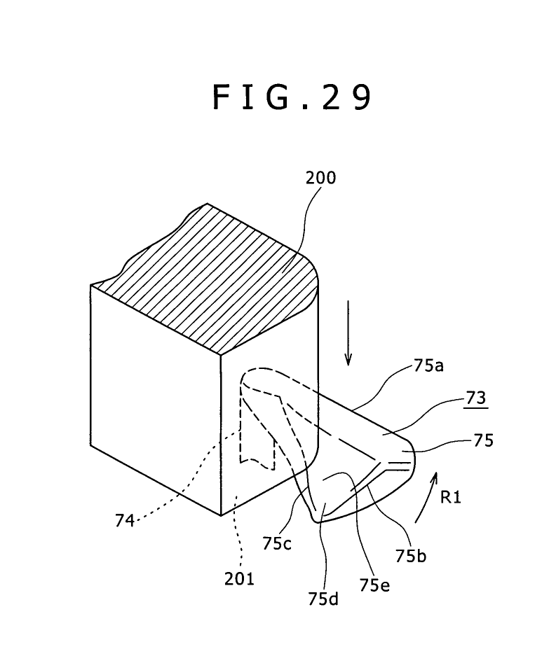

As shown in FIG. 29, the locking member 73 can be turned in the direction of the arrow R1 by pressing the battery 200 against the beveled surface 75e of the locking part 75 downward or obliquely downward. More specifically, when the battery 200 is pressed against the beveled surface 75e of the locking part 75 downward or obliquely downward, the battery 200 slides along the beveled surface 75e and the locking part 75 turns in the direction of the arrow R1.

The locking member 73 can be turned in the direction of the arrow R1 by thus pressing the battery 200 against the beveled surface 75e of the locking part 75 downward or obliquely downward and hence the battery 200 can be easily loaded into the battery receiving chamber 17a.

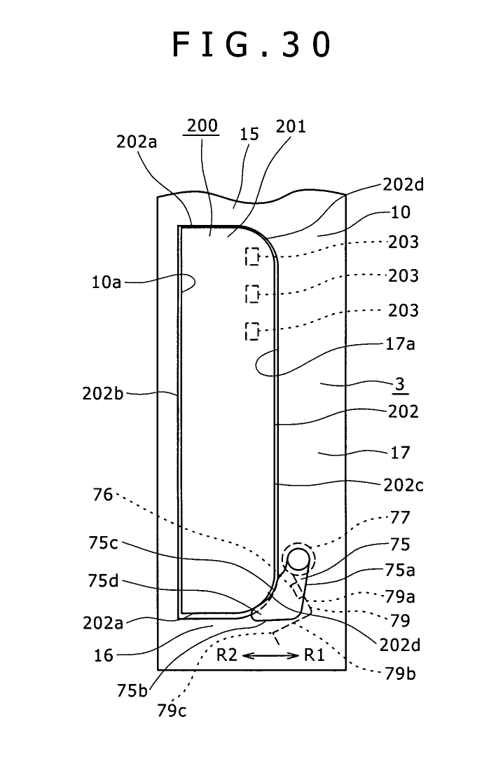

The first leg 79 of the spring 77 in elastic contact with the spring retaining part 76 is turned substantially forward as the locking member 73 is turned in the direction of the arrow R1. Consequently, the end part 79c of the spring 77 is advanced into the through hole 16a (FIG. 30).

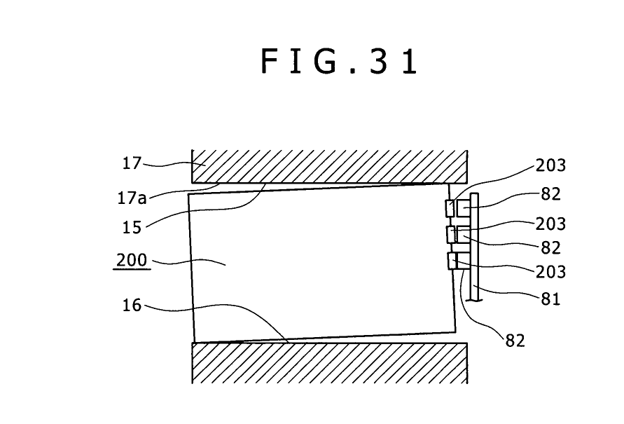

The battery receiving chamber 17a is formed in dimensions slightly greater than those of the battery 200 to form gaps between the surfaces of the battery receiving chamber 17a and the battery 200 so that the battery 200 can be easily loaded into the battery receiving chamber 17a. Therefore, in some cases, the battery 200 loaded into the battery receiving chamber 17a tilts relative to the battery receiving chamber 17a as shown in FIG. 31. If the battery 200 tilts relative to the battery receiving chamber 17a, it is possible that the terminals 203 of the battery 200 do not come into correct contact with the terminals 82.

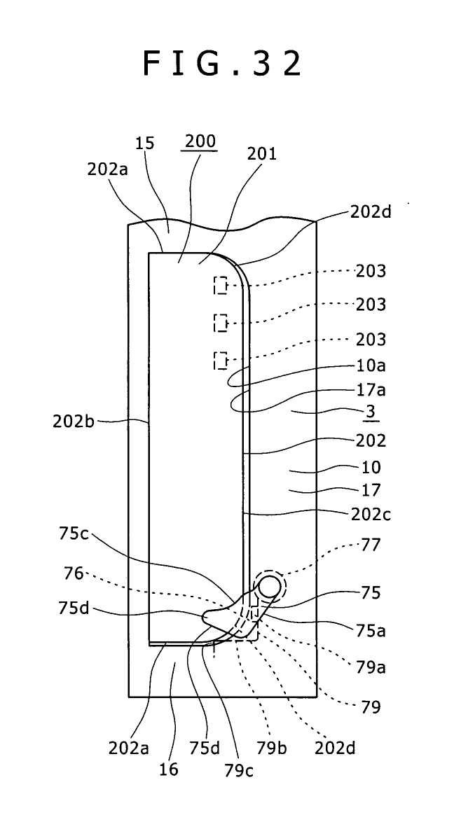

The locking member 73 is turned in the direction of the arrow R2 (FIG. 30) by the resilience of the spring 77 after the battery 200 has been loaded into the battery receiving chamber 17a. Thus the first leg 79 moves substantially rearward, the end part 79c projects through the through hole 16a into the battery receiving chamber 17a as shown in FIG. 32.

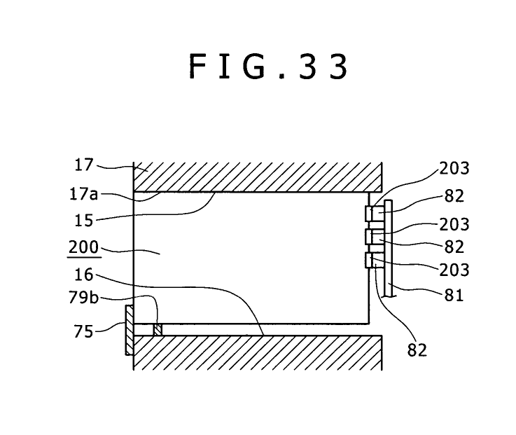

When the locking member 73 is turned in the direction of the arrow R2, the locking part 75 comes into contact with the end surface 201 of the battery 200 to lock the battery 200 in place in the battery compartment 17 as shown in FIGS. 32 and 33. The end part 79c projecting through the through hole 16a into the battery receiving chamber 17a presses the battery 200 against the battery aligning wall 15 to place the battery 200 in a correct position in the battery receiving chamber 17a as shown in FIGS. 32 and 33. Consequently, the terminals 203 of the battery 200 come into correct contact with the terminals 82, respectively.

The battery cover 13 is closed to complete the battery loading operation for loading the battery 200 into the battery compartment 17.

To unload the battery 200 from the battery compartment 17, the battery cover 13 is opened, the locking member 73 is turned to unlock the battery 200, and then the battery 200 is extracted from the battery receiving chamber 17a.

The pressing part 79b of the spring 77, namely a pressing means for applying pressure to the side surface of the battery 200, and the locking member 73, namely, a locking means, are interlocked. The locking member 73 locks the battery 200 and, at the same time, the pressing part 79b presses the battery 200. The locking member 73 unlocks the battery 200 and, at the same time, the pressing part 79b removes pressure from the side surface of the battery 200.

The pressing part 79b presses the battery 200 against the battery aligning wall 15 when the battery 200 is locked in place in the battery compartment 17. Therefore, the terminals 203 can be securely held in contact with the terminals 82. When the battery 200 is unlocked and the pressure applied to the side surface of the battery 200 by the pressing part 79b is removed, the battery 200 can be smoothly loaded into and unloaded from the battery receiving chamber 17a.

Since the locking member 73 does not apply pressure to the side surface of the battery 200 and the end part 79c of the spring 77 applies pressure to the side surface of the battery 200. The locking means and the pressing means can be formed in optimum shapes according to their functions, respectively. Consequently, the degree of freedom of design increases and the component parts can be efficiently arranged.

In the foregoing description, the spring 77 is supported on the locking member 73 to interlock the locking means and the pressing means by way of example. The locking means and the pressing means may be interlocked by a suitable linking means.

The locking member 73 is turned on the shaft 74 and the pressing part 79b turns together with the locking member 73 in the same direction when the locking member 73 is turned. Therefore, operational reliability can be insured, the locking member 73 and the pressing part 79b can operate in a small space and hence the electronic device 1 can be miniaturized.

The pressing part 79b serving as the pressing means is a part of the spring 77. Therefore, plays resulting from the tolerances in the component members can be absorbed by pressing the battery 200 against the battery aligning wall 15 and the battery 200 can be pressed against the battery aligning wall 15 by a proper pressure.

The locking part 75 of the locking member 73 has the curved part 75c extended such that the width of the locking part 75 increases with distance from the shaft 74, and the battery 200 is locked in the battery compartment 17 by bringing the locking part 75 into contact with the end surface 201 of the battery 200. Therefore, the locking part 75 is in contact with the end surface 201 in a large area and hence the battery 200 can be stably locked.

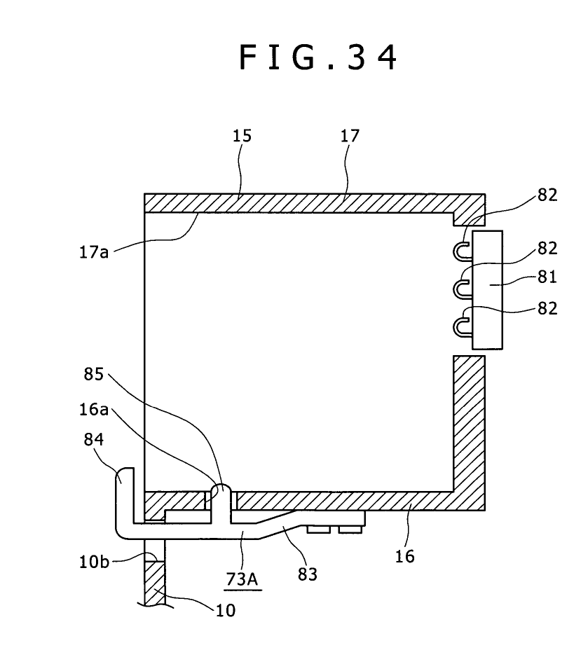

An elastic locking member 73A shown in FIGS. 34 to 36 may be used instead of the locking member 73 for locking the battery 200. The elastic locking member 73A can be elastically deformed.

The locking member 73A is made of a material capable of being greatly elastically deformed, such as a resin. As shown in FIG. 34, the locking member 73A has a laterally elongate base part 83, a locking part 84 projecting from a first end, namely, one of opposite ends, of the base part 83 in a direction perpendicular to the base part 83, and a pressing part 85 projecting from a middle part of the bas part 83 in a direction perpendicular to the base part 83.

A second end, namely, the other end, of the base part 83 of the locking member 73A is attached to the holding wall 16 such that the locking part 84 extends outside through the hole 10b of the right wall 10, a part of the locking part 84 is positioned in front of the battery receiving chamber 17a and an end part of the pressing part 85 projects through the through hole 16a of the holding wall 16 into the battery receiving chamber 17a.

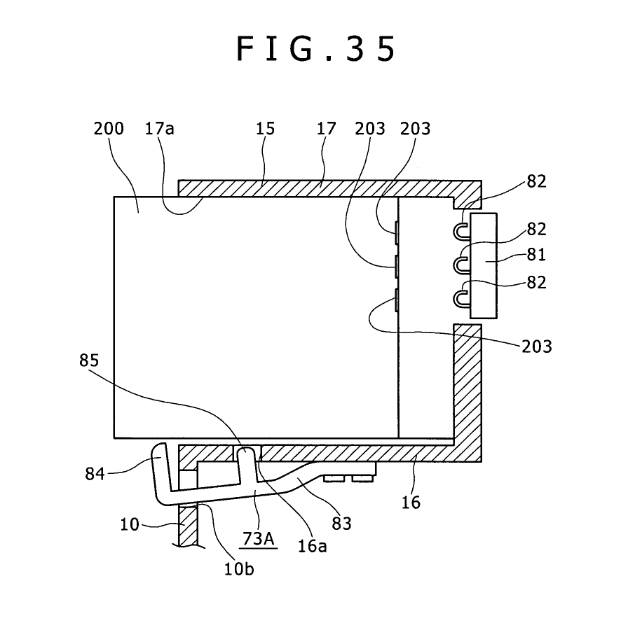

When the battery 200 is loaded into the battery receiving chamber 17a, the locking member 73A is bent so as to retract the pressing part 85 into the hole 16a from the battery receiving chamber 17a as shown in FIG. 35. In this state, the battery 200 can be loaded smoothly into the battery receiving chamber 17a.

After the battery 200 has been loaded into the battery receiving chamber 17a, the locking member 73A is released. Then, the locking member 73A restores its original shape by its resilience, the locking part 84 locks the battery 200 and the pressing part 85 presses the battery 200 against the battery aligning wall 15. Consequently, the battery 200 is held in a correct position in the battery receiving chamber 17a with its terminals 203 connected correctly to the terminals 82.

To unload the battery 200 from the battery receiving chamber 17a, the locking member 73A is bent to open the battery receiving chamber 17a and to remove pressure applied to the battery 200 by the pressing part 85.

Since the base part 83, the locking part 84 and the pressing part 85 of the locking member 73A are formed integrally, the number of component parts can be reduced.

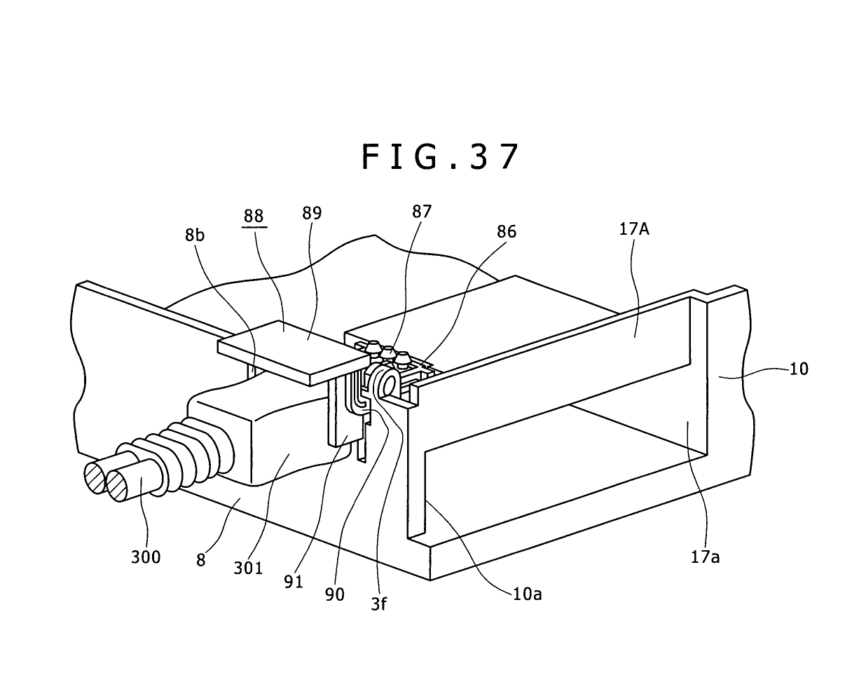

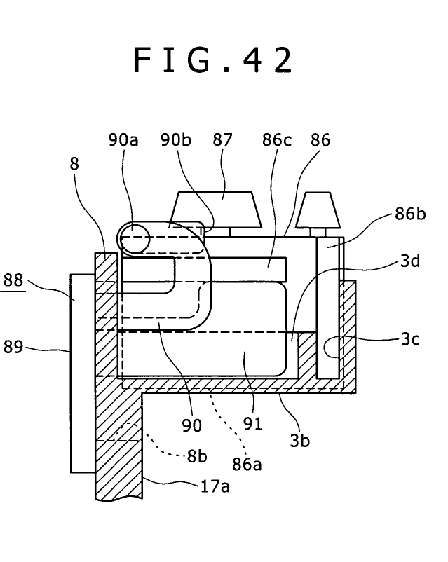

Another battery compartment and parts of the battery compartment will be described with reference to FIGS. 37 to 44.

The component parts of the electronic device 1 can be driven by either of power from the battery 200 and power from a commercial power source.

The electronic device 1 is provided with the following mechanism that inhibits simultaneous power supply by both the battery 200 and the commercial power source.

If both the battery 200 and the commercial power source supply power simultaneously, it is possible that the battery 200 does not satisfactorily achieve a power-saving operation. It is possible to provide the electronic device 1 with a circuit that interrupts power supply from the battery 200 when the power cable of the electronic device 1 is connected to a commercial power source. However such a circuit makes the circuit configuration of the electronic device 1 complicated and increases the cost of the electronic device 1.

As shown in FIG. 37, a battery compartment 17A in another embodiment according to the present invention defines a battery receiving chamber 17a having an opening 10a formed in the right wall 10 of the middle frame 3.

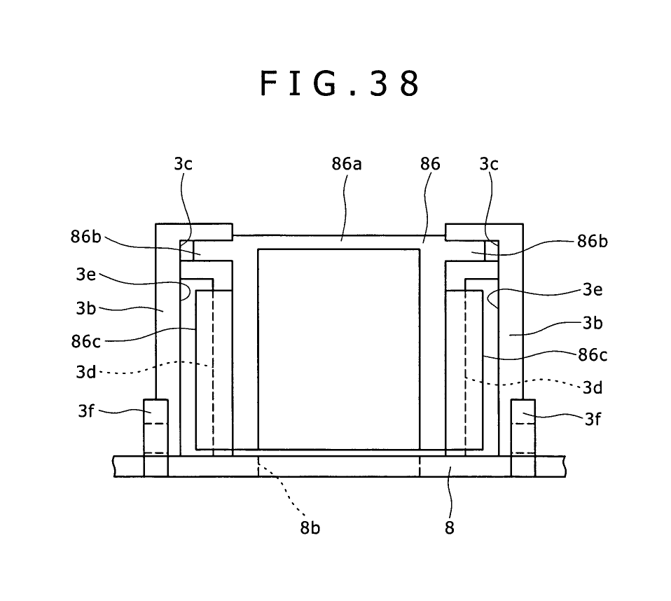

The lower wall 8 of the middle frame 3 is provided with a jack receiving opening 8b opening into the interior of the middle frame 3 at a position near the opening 10a as shown in FIG. 38.

The middle frame 3 is provided with laterally spaced support walls 3b. The support walls 3b extend from parts near the jack receiving opening 8b into the interior of the middle frame 3. Guide grooves 3c are formed in inner end parts of the support walls 3b so as to open inward. Stopper walls 3d extend parallel to the support walls 3b from the lower wall 8 of the middle frame 3 on the inner side of the support walls 3b. End parts of the stopper walls 3d are continuous with the lower wall 8 in which the guide grooves 3c are formed. A recess 3e is formed between each of the support walls 3b and the stopper wall 3d near the support wall 3b. Parts of a connector jack 87 are inserted into the recesses 3e, respectively.

Laterally spaced knuckles 3f are formed on the lower wall 8 of the middle frame 3 at positions behind the support walls 3b, respectively.

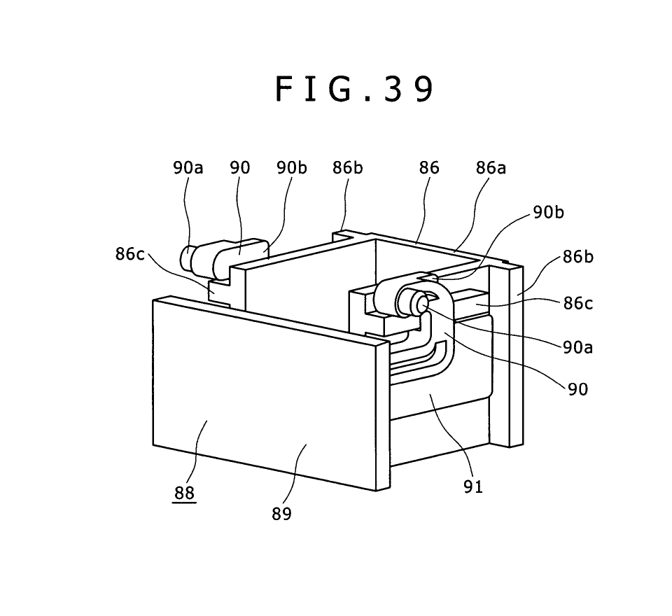

As shown in FIG. 38, a jack case 86 is movably supported on the support walls 3b. Referring to FIGS. 38 and 39, the jack case 86 is a box having a body 86a having a rear and a lower open side, guide parts 86b protruding outward form the upper end of the body 86a, and stopping parts 86c protruding outward from parts of the body part 86a near the upper end of the body 86a. The guide parts 86b extend longitudinally and the stopping part 86c extend vertically.

The guide parts 86b of the jack case 86 are fitted in the guide groove 3c of the middle frame 3 so as to slide longitudinally on the support wall 3b.

As shown in FIGS. 37 and 39, the connector jack 87 is disposed in the body 86a of the jack case 86. A plug 301 connected to a free end of a power cable 300 to be connected to a commercial power source is connected to the connector jack 87. The connector jack 87 is connected to a power circuit, not shown, held in the body 2 of the electronic device 1.

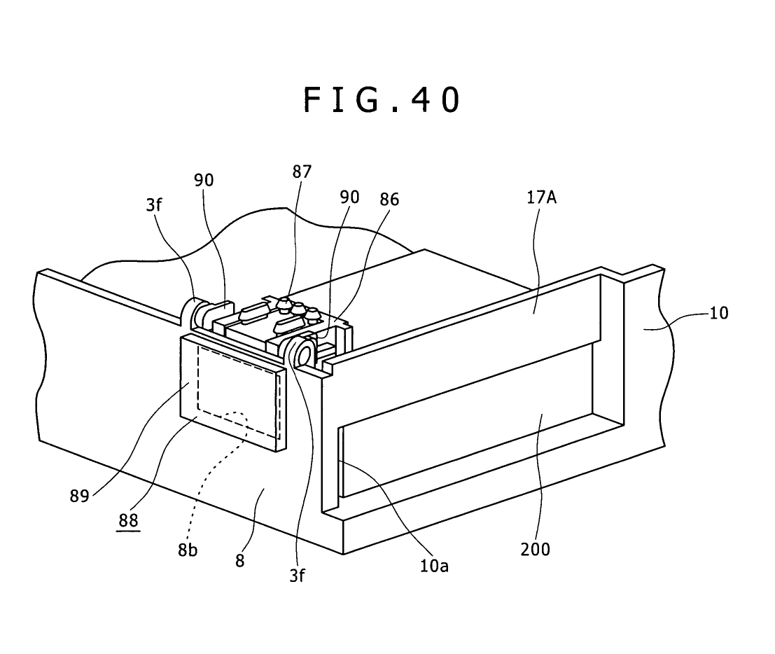

As shown in FIGS. 37 and 40, a cover 88 is supported pivotally on the knuckles 3f of the middle frame 3.

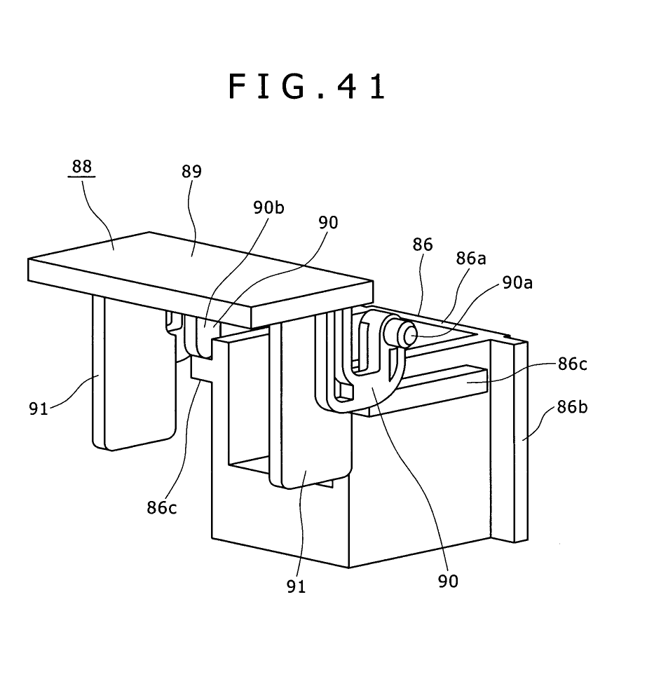

Referring to FIGS. 39 and 41, the cover 88 has a covering plate 89 having the shape of a flat plate, legs 90 extending from the right and the left end of the covering part 89, respectively, and operating plates 91 extending from parts of the covering plate 89 near the right and the left end of the covering plate 89 in the same direction as the legs 90. The legs 90 are formed in a shape substantially resembling the letter U. Pivotal pins 90a project outward from the outer side surfaces of end parts of the legs 90a, respectively. Operating protrusions 90b protrude inward from the inner side surfaces of the end parts of the legs 90, respectively.

The pivotal pins 90a are fitted in holes formed in the knuckles 3f.The cover 88 can turn on the pivotal pins 90a relative to the middle frame 3 to open and close the jack receiving opening 8b.

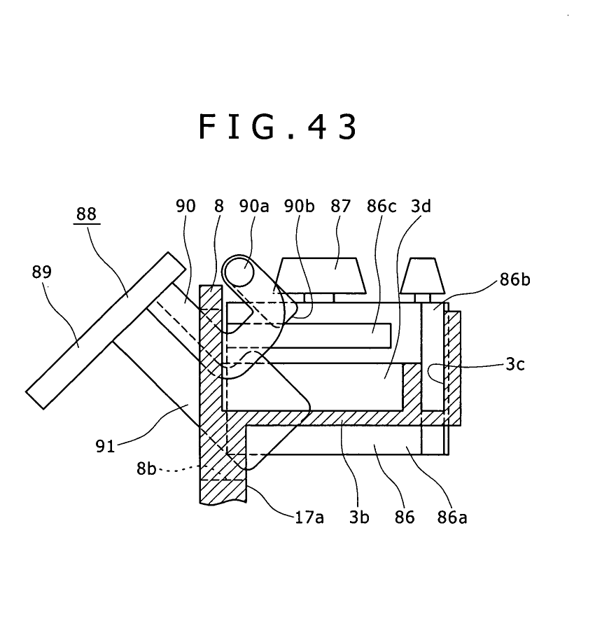

Referring to FIG. 43, when the jack receiving opening 8b is covered with the cover 88, each of the stopping parts 86c of the jack case 86 is held between the operating protrusion 90b of the leg 90 and the operating plate 91. Each of the legs 90 and each of the operating plates 91 are received in the recess 3e formed between the support wall 3b and the stopper wall 3d. In this state, the jack case 86 is at the rear end of a moving range and the battery receiving chamber 17a is fully opened. Therefore, the jack receiving opening 8b is covered with the cover 88 thereby to inhibit the connection of the plug 301 to the connector jack 87 and the battery 200 can be loaded into the battery compartment t 17. Thus only the battery 200 can supply power.

When the cover 88 is turned in a state where the battery 200 is not held in the battery compartment 17, the operating plates 91 separate from the stopping parts 86c of the jack case 86, the operating protrusions 90b presses the stopping parts 86c, and the jack case 86 moves forward together with the connector jack 87 along the guide grooves 3c as shown in FIG. 43.

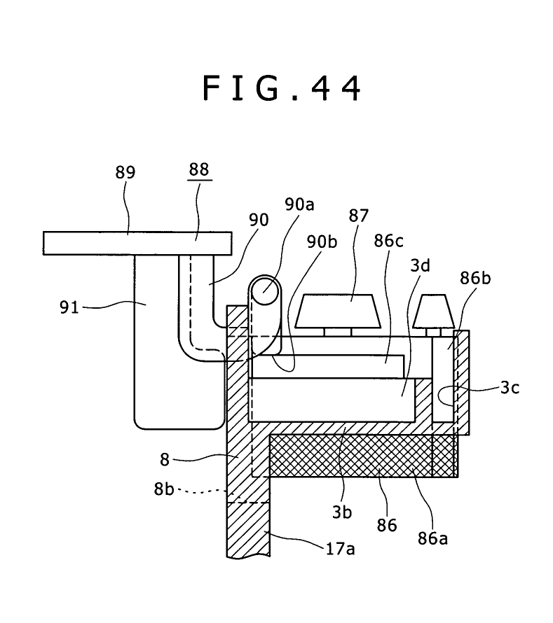

As the cover 88 is turned further, the operating plates 91 separate further from the stopping parts 86c of the jack case 86, the operating protrusions 90b presses the stopping parts 86c, and the jack case 86 moves further forward together with the connector jack 87 as shown in FIG. 44. Finally the cover 88 is fully opened to open the jack receiving opening 8b. The stopping parts 86c of the jack case 86 come into contact with the stopper walls 3d of the support walls 3b, respectively, to limit the forward movement of the jack case 86.

In this state, a part of the jacket case 86, i.e., a shaded part shown in FIG. 44, lies in the battery receiving chamber 17a. Therefore, insertion of the battery 200 into the battery receiving space 17a is obstructed by the part of the jack case 86 lying in the battery receiving chamber 17a. Therefore, when the cover 88 is opened to open the jack receiving opening 8b, the plug 301 can be connected to the connector jack 87 and it may be impossible for the battery 200 to be loaded into the battery compartment 17. Thus only the commercial power source can supply power.

If it is tried to open the jack receiving opening 8b by turning the cover 88 in a state shown in FIG. 40 where the battery 200 has been loaded into the battery compartment 17, the movement of the jack case 86 is obstructed by the battery 200. Therefore, it may be impossible for the cover 88 to be turned and also impossible for the jack receiving opening 8b to be opened.

The electronic device 1 is provided with this mechanism that inhibits simultaneous power supply by both the battery 200 and the commercial power source. Therefore, power is not supplied simultaneously by both the battery 200 and the commercial power source and hence the battery 200 can satisfactorily achieve a power-saving operation.

The power circuit does not need to be designed so that power cannot be supplied from the battery 200 in a state where the power cable 300 is connected to the commercial power source. Therefore, the power circuit is not complicated and does not increase the manufacturing cost of the electronic device 1.

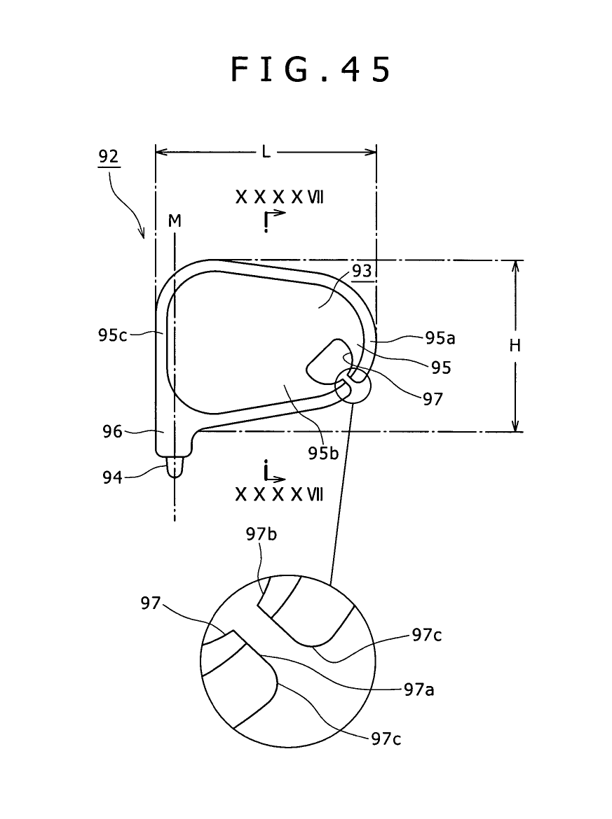

An input pen 92 capable of entering information into the touch panel 57 on a handwriting mode will be described with reference to FIGS. 45 to 52.

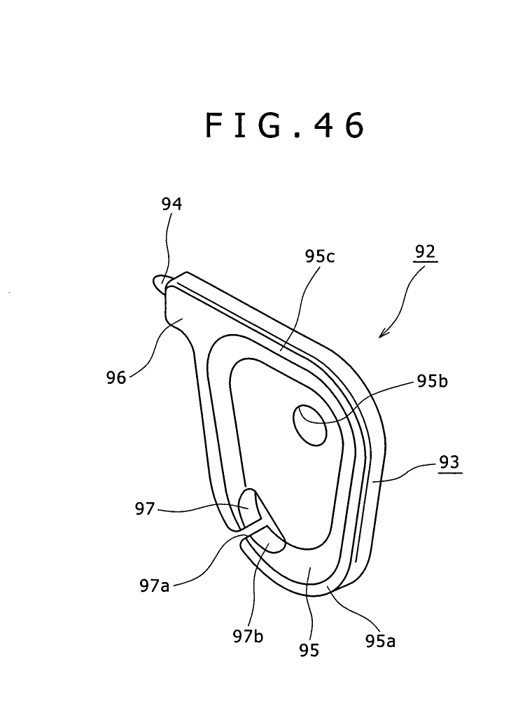

The input pen 92 is made of, for example, a resin. As shown in FIGS. 45 and 46, the input pen 92 has a grip 93 having a shape substantially resembling a flat plate and a pointed tip 94 formed integrally with the grip 93.

The grip 93 has a major part 95 and a nose 96 protruding from the major part 95.

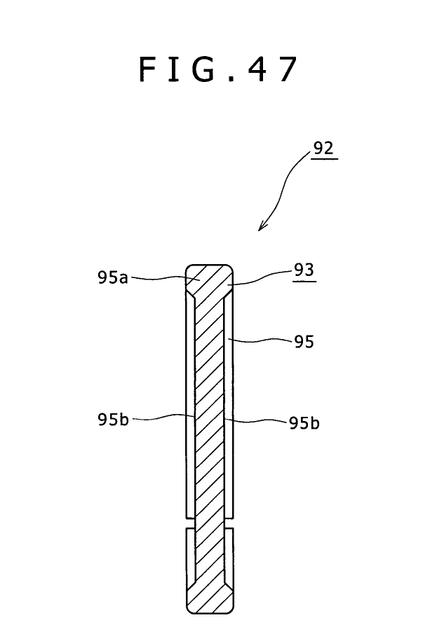

The major part 95 has a rim 95a of a thickness greater than that of other part of the major part 95. The rim 95a surrounds depressed surfaces 95b as shown in FIG. 47. The depressed surfaces 95b are opposite side surfaces of the major part 95.

The major part 95 has a straight part 95c extending along a direction in which the pointed tip 94 extends. As shown in FIG. 45, the straight part 95c extends near the center axis M of the pointed tip 94. The major part 95 has a shape substantially resembling a flat plate containing the center axis M.

The grip 93 has a length L, namely, a dimension in a direction perpendicular to the center axis M, and a width H, namely, a dimension in a direction parallel to the center axis M. As shown in FIG. 45, the length L is greater than the width H.

The nose 96 has an axis aligned with the center axis M. The pointed tip 94 protrudes from the front end of the nose 96. The straight part 95c of the grip 93 is continuous with the pointed tip 94. Thus the pointed tip 94 merges into the grip 93.

A part of the grip 93 opposite the straight part 95c is provided with strap holding structure 97 for holding a strap 400. The strap holding structure 97 having a guide groove 97a formed in a peripheral part of the grip 93 so as to open in the periphery of the grip 93, and a strap receiving opening 97b continuous with the guide groove 97a and extending between the depressed surfaces 95b.

The guide groove 97a has a width smaller than that of the strap receiving opening 97b. The guide groove 97a has a tapered guide part 97c tapering toward the strap receiving opening 97b and a straight part having a substantially fixed width and extending from the strap receiving opening 97b toward the tapered guide part 97c.

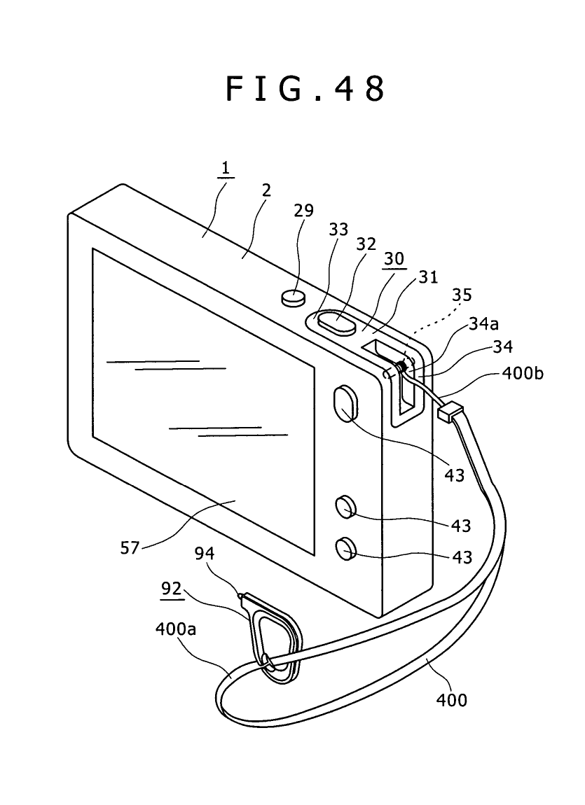

As shown in FIG. 48, an end part 400a of the strap 400 is passed through the strap receiving opening 97b of the strap holding structure 97. The strap 400 can be easily inserted through the guide groove 97a having the tapered guide part 97c tapering toward the strap receiving opening 97b into the strap receiving opening 97. The straight part of the guide groove 97a has a fixed width. Therefore, it is difficult for the end part 400a of the strap 400 passed through the strap receiving opening 97b to come off the strap receiving opening 97b through the guide groove 97a. Thus the input pen 92 can be prevented from coming off the strap 400.

As shown in FIG. 48, a loop 400b attached to the other end part of the strap 400 is wound round the pin 35 inserted into the through holes 34b of the shutter unit 30.

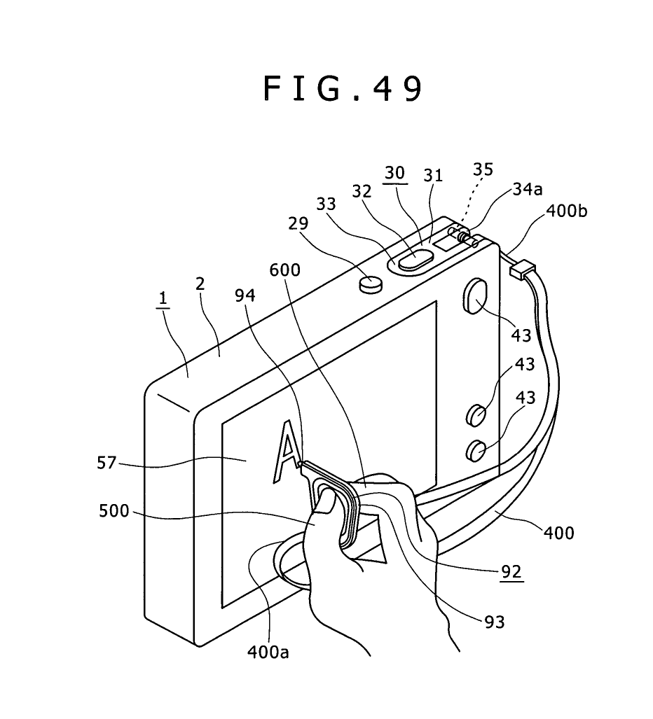

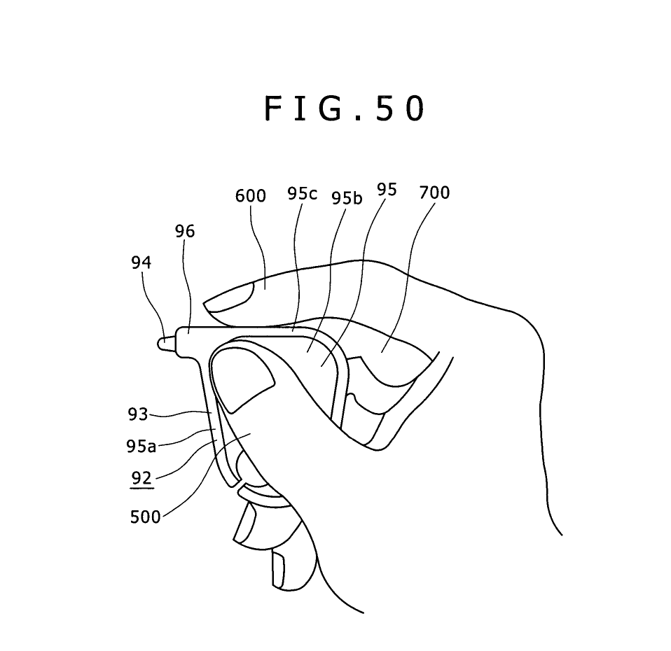

The use of the input pen 92 for entering information by handwriting will be described with reference to FIGS. 49 and 50.

The user holds the input pen 92 by, for example, putting the thumb 500 and the index finger 600 respectively on the depressed surfaces 95b of the grip 93 as shown in FIG. 49. The user is able to hold the input pen 92 by putting the thumb 500 and the middle finger 700 respectively on the depressed surfaces 95b and putting the index finger 600 on the straight part of the grip 93 as shown in FIG. 50.

The user holding the input pen 92 presses the pointed tip 94 against the surface of the touch panel 57 or presses the pointed tip 94 against and moves the same along the surface of the touch panel 57 to enter desired instructions and letters.

Since an area of contact between the grip 93 of the input pen 92 and users fingers is large when the user grips the grip 93 of the input pen 92 the grip 93 of the input pen 92 has the shape of a flat plate containing the center axis M of the pointed tip 94. Thus the input pen 92 can be firmly held between the user's fingers and facilitates a handwriting input operation.

Since the grip 93 of the input pen 92 is formed in the shape of a flat plate instead of in the shape of a round rod, the grip 93 held between the user's fingers is unable to turn on the user's hand and hence the user does not need to grip the input pen 92 firmly and may grip the input pen 92 loosely.

Since the straight part 95c of the grip 93 is on the extension of the pointed tip 94 and the pointed tip 94 is continuous with the grip 93, a handwriting input operation will not be obstructed by shadows of the input pen 92 and the user's fingers reflected in the touch panel 57 and hence a handwriting input operation can be accurately and easily achieved.

Since the length L of the grip 93 in a direction perpendicular to the center axis M is greater than the width H in a direction parallel to the center axis M, the grip 93 is easy to grip.

Since the depressed surfaces 95b are formed in the grip 93, the fingers holding the grip 93 can be prevented from coming off the grip 93 by the rim 95a surrounding the depressed surfaces 95b even if the fingers slip on the depressed surfaces 95b.

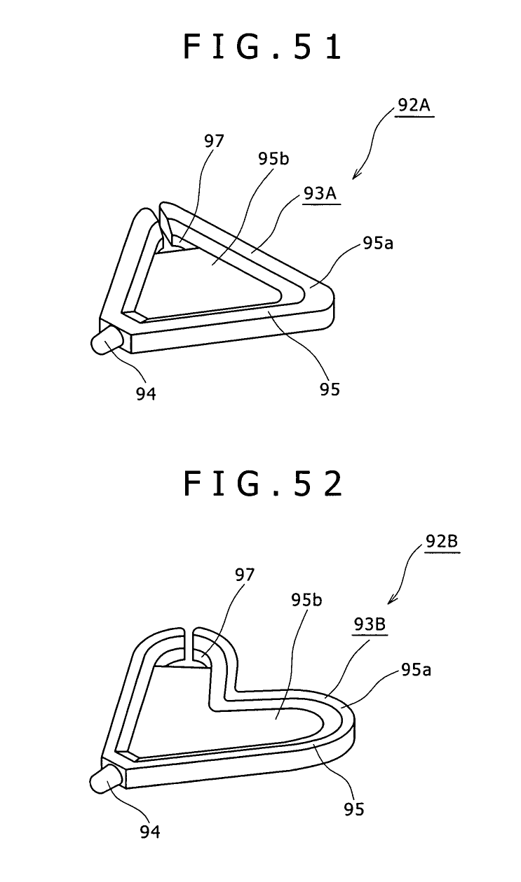

The grip 93 of the input pen 92 can be formed in an optional shape provided that the grip 93 is flat. For example, the present invention may be embodied by an input pen 92A having a substantially triangular grip 93A as shown in FIG. 51 or an input pen 92B having a heart-shaped grip 93B as shown in FIG. 52.

The shapes and construction of the parts of the embodiment of the present invention specifically described herein are only examples and are not limitative and restrictive.

It should be understood by those skilled in the art that various modifications, combinations, sub-combinations and alterations may occur depending on design requirements and other factors insofar as they are within the scope of the appended claims or the equivalents thereof.

What is claimed is:

1. An input pen for entering information into an input device by a handwriting input operation, the input pen comprising:
a grip, to be held by a user for a handwriting input operation, having a shape substantially resembling a flat plate; and
a pointed tip continuous with the grip;
wherein the grip contains an axis aligned with a center axis of the pointed tip.

2. The input pen according to claim 1, wherein an end part of the grip extends toward the pointed tip and is connected to the pointed tip.

3. The input pen according to claim 1, wherein a dimension of the grip in a direction perpendicular to the axis of the grip is greater than a dimension in a direction parallel to the axis of the grip.

4. The input pen according to claim 1, wherein an inner part of the grip surrounded by a peripheral part of the grip has depressed opposite surfaces.

5. The input pen according to claim 1, wherein the grip has a strap holding structure, for holding a strap, having a strap receiving opening and a guide groove continuous with the strap receiving opening and formed in a peripheral part of the grip so as to open in the periphery of the grip, the strap receiving opening has a width greater than that of the guide groove, the guide groove has a tapered guide part tapering toward the strap receiving opening and a straight part having a substantially fixed width and extending from the strap receiving opening toward the tapered guide part.
